(19) United States
(12) Patent Application Publication
(10) Pub. No.: US 2026/0283760 A1
(43) Pub. Date: Sep. 24, 2026

(54) GENERATING REALISTIC DENTAL TREATMENT IMAGES USING 3D FACIAL AND DENTAL MODELS

(71) Applicant: Align Technology, Inc., San Jose, CA (US)

(72) Inventors: Shipra Jain, Zürich (CH); Michael Chang, Zürich (CH); Andreea Maria Radoescu, Baden (CH); Niko Benjamin Huber, Zug (CH)

(21) Appl. No.: 19/568,648

(22) Filed: Mar. 16, 2026

Related U.S. Application Data
(60) Provisional application No. 63/774,032, filed on Mar. 18, 2025.

(51) Int. Cl. A61C 13/00; A61C 7/00; G06T 7/38; G06T 17/00

(52) U.S. Cl. CPC A61C 13/0004; A61C 7/002; G06T 7/38; G06T 17/00; G06T 2200/08; G06T 2207/20081; G06T 2207/30036

(57) ABSTRACT

A method includes obtaining a 3D head model including a depiction of a current head of a patient; obtaining a first 3D dentition model including a depiction of the current dentition of the patient and a second 3D dentition model including a depiction of an altered dentition of the patient; registering the first 3D dentition model to the 3D head model; generating one or more first images of the 3D head model in one or more poses and generating one or more second images of the second 3D dentition model corresponding to the one or more poses based at least in part on a result of the registering; and generating modified versions of the one or more first images by replacing the current dentition of the patient with the altered dentition of the patient from the one or more second images.

### RELATED APPLICATIONS

This patent application claims the benefit under 35 U.S.C. § 119(e) of U.S. Provisional Application No. 63/774,032, filed Mar. 18, 2025, which is incorporated by reference herein.

### TECHNICAL FIELD

The instant specification generally relates to systems and methods for dental treatment visualization, and in particular to systems and methods for generating realistic dental treatment images and/or videos using three-dimensional (3D) facial and dental models.

### BACKGROUND

Dental treatments help patients achieve desired dental and orthodontic outcomes, including straightening teeth, correcting bite problems, closing gaps between teeth, aligning teeth and other oral anatomy. Such dental treatments often include using aligners, retainers, braces, and other components to shift the positions of a patient's oral anatomy. Sometimes, it can help a patient to decide whether to undergo treatment by providing visualizations of the patient's oral anatomy during various stages of the dental treatment.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor delineate any scope of the particular embodiments of the disclosure or any scope of the claims. Its sole purpose is to present some concepts of the disclosure in a simplified form as a prelude to the more detailed description that is presented later.

In a first example implementation, a method for generating realistic dental treatment images using three-dimensional (3D) facial and dental models includes: obtaining a 3D head model including a depiction of a current head of a patient, the 3D head model including a representation of at least a portion of a current dentition of the patient; obtaining a first 3D dentition model including a depiction of the current dentition of the patient and a second 3D dentition model including a depiction of an altered dentition of the patient; registering the first 3D dentition model to the 3D head model; generating one or more first images of the 3D head model in one or more poses; generating one or more second images of the second 3D dentition model corresponding to the one or more poses based at least in part on a result of the registering; and generating modified versions of the one or more first images by replacing the current dentition of the patient with the altered dentition of the patient from the one or more second images.

In a second example implementation, a system for generating realistic dental treatment images using 3D facial and dental models includes: one or more processors and a memory coupled to the one or more processors that stores computer program instructions that, when executed by the one or more processors, perform a computer-implemented method that includes obtaining a 3D head model including a depiction of a current head of a patient, the 3D head model including a representation of at least a portion of a current dentition of the patient; obtaining a first 3D dentition model including a depiction of the current dentition of the patient and a second 3D dentition model including a depiction of an altered dentition of the patient; registering the first 3D dentition model to the 3D head model; generating one or more first images of the 3D head model in one or more poses; generating one or more second images of the second 3D dentition model corresponding to the one or more poses based at least in part on a result of the registering; and generating modified versions of the one or more first images by replacing the current dentition of the patient with the altered dentition of the patient from the one or more second images.

In a third example implementation, a computer-readable storage medium for generating realistic dental treatment images using 3D facial and dental models includes instructions, when executed by one or more processors, performs a computer-implemented method that includes obtaining a 3D head model including a depiction of a current head of a patient, the 3D head model including a representation of at least a portion of a current dentition of the patient; obtaining a first 3D dentition model including a depiction of the current dentition of the patient and a second 3D dentition model including a depiction of an altered dentition of the patient; registering the first 3D dentition model to the 3D head model; generating one or more first images of the 3D head model in one or more poses; generating one or more second images of the second 3D dentition model corresponding to the one or more poses based at least in part on a result of the registering; and generating modified versions of the one or more first images by replacing the current dentition of the patient with the altered dentition of the patient from the one or more second images.

In a fourth example implementation, a first computing device is configured to obtain a 3D head model including a depiction of a current head of a patient, the 3D head model including a representation of at least a portion of a current dentition of the patient; obtain a first 3D dentition model including a depiction of the current dentition of the patient and a second 3D dentition model including a depiction of an altered dentition of the patient; register the first 3D dentition model to the 3D head model; generate one or more first images of the 3D head model in one or more poses; and generate one or more second images of the second 3D dentition model corresponding to the one or more poses based at least in part on a result of the registering. The first computing device is further configured to transmit the one or more first images and the one or more second images to a second computing device. The second computing device is configured to generate modified versions of the one or more first images by replacing the current dentition of the patient with the altered dentition of the patient from the one or more second images.

In a fifth example implementation, a first computing device is configured to obtain a 3D head model including a depiction of a current head of a patient, the 3D head model including a representation of at least a portion of a current dentition of the patient; obtain a first 3D dentition model including a depiction of the current dentition of the patient and a second 3D dentition model including a depiction of an altered dentition of the patient; register the first 3D dentition model to the 3D head model; generate one or more first images of the 3D head model in one or more poses; generate one or more second images of the second 3D dentition model corresponding to the one or more poses based at least in part on a result of the registering; and generate modified versions of the one or more first images by replacing the current dentition of the patient with the altered dentition of the patient from the one or more second images. The first computing device is further configured to transmit the modified versions of the one or more first images to a second computing device. The second computing device is configured to present the one or more modified versions of the one or more first images on a display.

### BRIEF DESCRIPTION OF THE DRAWINGS

Aspects and embodiments of the present disclosure will be understood more fully from the detailed description given below and from the accompanying drawings of various aspects and embodiments of the disclosure, which, however, should not be taken to limit the disclosure to the specific aspects or embodiments, but are for explanation and understanding only.

FIG. 1 illustrates a schematic block diagram of an example system for generating realistic dental treatment images using three-dimensional (3D) facial and dental models, in accordance with some embodiments of the present disclosure.

FIG. 2A illustrates a flow diagram of an example method for generating realistic dental treatment images using 3D facial and dental models, in accordance with some embodiments of the present disclosure.

FIG. 2B illustrates a flow diagram continuing the example method for generating realistic dental treatment images using 3D facial and dental models of FIG. 2A, in accordance with some embodiments of the present disclosure.

FIG. 3 illustrates a flow diagram of an example method for generating realistic dental treatment images using 3D facial and dental models, in accordance with some embodiments of the present disclosure.

FIG. 4 illustrates a flow diagram of an example method for generating realistic dental treatment images using 3D facial and dental models, in accordance with some embodiments of the present disclosure.

FIG. 5 illustrates a flow diagram of an example method for generating realistic dental treatment images using 3D facial and dental models, in accordance with some embodiments of the present disclosure.

FIG. 6 illustrates a flow diagram of an example data flow for generating realistic dental treatment images using 3D facial and dental models, in accordance with some embodiments of the present disclosure.

FIG. 7 illustrates a flow diagram of an example data flow for generating realistic dental treatment images using 3D facial and dental models, in accordance with some embodiments of the present disclosure.

FIG. 8A illustrates an example 3D head model, in accordance with some embodiments of the present disclosure.

FIG. 8B illustrates an example 3D dentition model, in accordance with some embodiments of the present disclosure.

FIG. 8C illustrates an example 3D dentition model, in accordance with some embodiments of the present disclosure.

FIGS. 9A-C illustrate example modified images of 3D head models in various poses, in accordance with some embodiments of the present disclosure.

FIG. 10 depicts a block diagram of an example processing device operating in accordance with one or more embodiments of the present disclosure.

### DETAILED DESCRIPTION

Dental treatment can refer to treating a patient's teeth and other oral anatomy to achieve desired dental outcomes, including straightening teeth, correcting bite problems, closing gaps between teeth, and aligning teeth and other oral anatomy. Such dental treatments often include the patient's use of aligners, retainers, braces, and other components to shift the positions of a patient's oral anatomy. Some dental treatments can occur over several months or even years.

A patient may desire to see a visual representation of what the patient's teeth and other oral anatomy will look like during various stages of a dental treatment. While a dental professional may be able to create mock-up visualizations that can give some idea of what the patient's dentition will look like during or after the dental treatment, such visualizations may be of poor visual quality. For example, the color of the teeth in the visualization may not match the patient's teeth color, the images may not appear realistic, the view of the patient's head may be limited to largely a front view, and so on.

Aspects and implementations of the present disclosure address the above and other challenges by providing systems and methods for generating realistic dental treatment images and/or videos (e.g., temporal sequences of images) using three-dimensional (3D) facial and dental models. In embodiments, methods and systems for generating images and/or videos of an altered condition (e.g., an estimated future condition) of an individual's head, face, smile and/or dentition based on generating images and/or a video of a current condition of the patient's head, face, smile and/or dentition from a 3D model, and modifying a captured the images and/or video of the current condition of the individual's head, face, smile and/or dentition based on information on an estimated future condition of the patient's dentition.

The systems and methods described herein may obtain a 3D head model of a patient, which may include a depiction the patient's face or other head anatomy in a current condition. The 3D head model may have been generated from one or more scans of the patient's head performed by a 3D imaging system (e.g., a head scanning system) in embodiments. The systems and methods may obtain a 3D dentition model of the patient, which may include a depiction of the patient's dentition as it currently exists. The 3D dentition model may be generated based on an intraoral scan of the patient. The systems and methods may obtain another 3D dentition model, which may include a depiction of an altered dentition of the patient. The other 3D dentition model may be generated based on performing treatment planning of the patient in embodiments. The altered dentition of the patient may include the patient's dentition as it is predicted to appear during a certain stage of dental treatment or after the dental treatment is completed. The systems and methods may obtain the 3D dentition model depicting the altered dentition from a dental treatment system that uses artificial intelligence (AI) to predict the configuration of the altered dentition in some embodiments. The systems and methods may register the 3D dentition model to the 3D head model, which may include aligning the 3D dentition model with a mouth area of the 3D head model. The systems and methods can generate images of the 3D head model in one or more poses that show the patient's current dentition. In embodiments, poses, facial expressions, zoom settings, etc. of the 3D head model may be adjusted for one or more generated images. For example, the images can show the patient's head with different smiles or mouth shapes, and/or the images can show the patient's head from different angles. Because the images include the patient's head in different poses and because the 3D dentition has been registered to the 3D head model, this information can be used to generate an altered 3D dentition image of the patient's current dentition in a matching pose to a generated image of the current condition of the patient's head. The two images may be processed in embodiments to generate an altered version of the head image that includes the patient's altered dentition that is aligned with the different head poses and appears realistic

The methods and systems described herein may perform a sequence of operations to identify areas of interest in one or more images (e.g., a sequence of images such as a video) generated from a 3D head model (e.g., such as a mouth area of a facial video), determine a future condition of the area of interest, and then modify the images (e.g., frames of the video) by replacing the current version of the area of interest with an estimated future version of the area of interest or other altered version of the area of interest. In embodiments, the other altered version of the area of interest may not correspond to a normally achievable condition. For example, an individual's dentition may be altered to reflect vampire teeth, monstrous teeth such as tusks, filed down pointed teeth, enlarged teeth, shrunken teeth, and so on. In other examples, an individual's dentition may be altered to reflect unlikely but possible conditions, such as edentulous dental arches, dental arches missing a collection of teeth, highly stained teeth, rotted teeth, and so on. In some embodiments, a video may include faces of multiple individuals, and the methods and systems may identify the individuals and separately modify the dentition of each of the multiple individuals. The dentition for each of the individuals may be modified in a different manner in embodiments.

In some embodiments, a 3D model of a patient's current dentition (e.g., teeth) is provided or determined, and based on the 3D model of the patient's dentition a treatment plan is created that may change teeth positions, shape and/or texture. A 3D model of the post-treatment condition of the patient's dentition is generated as part of the treatment plan. The 6D position and orientation of the pre-treatment dentition in 3D space may be tracked for frames of a video generated from different poses of a 3D head model based on fitting performed between the 3D head model and the 3D model of the current condition of the teeth.

The head images and/or video may be generated to have selected features such as color, lighting, appearance, and so on in some embodiments.

One or more deep learning models such as generative adversarial networks and/or other generative models may be used to generate a modified video or image that incorporates the post-treatment or other altered version of the dentition with the remainder of the contents of the frames/images generated from the 3D head model. With regards to videos, these operations are performed in a manner that ensures temporal stability and continuity between frames of the video, resulting in a modified video that may be indistinguishable from a real or unmodified video. The methods may be applied, for example, to show how a patient's teeth will appear after orthodontic treatment and/or prosthodontic treatment (e.g., to show how teeth shape, position and/or orientation is expected to change), to alter the dentition of one or more characters in and/or actors for a movie or film (e.g., by correcting teeth, applying one or more dental conditions to teeth, removing teeth, applying fantastical conditions to teeth, etc.), and so on. For example, the methods may be applied to generate videos showing visual impact to tooth shape of restorative treatment, visual impact of removing attachments (e.g., attachments used for orthodontic treatment), visual impact of performing orthodontic treatment, visual impact of applying crowns, veneers, bridges, dentures, and so on, visual impact of filing down an individual's teeth to points, visual impact of vampire teeth, visual impact of one or more missing teeth (e.g., of edentulous dental arches), and so on.

Embodiments are capable of pre-visualizing a variety of dental treatments and/or dental alterations that change color, shape, position, quantity, etc. of teeth. Examples of such treatments include orthodontic treatment, restorative treatment, implants, dentures, teeth whitening, and so on. The system described herein can be used, for example, by orthodontists, dental and general practitioners, and/or patients themselves. In embodiments, the system is usable outside of a clinical setting, and may be an image or video editing application that executes on a client device, may be a cloud-based image or video editing service, etc. For example, the system may be used for post-production of movies to digitally alter the dentition of one or more characters in and/or actors for the movie to achieve desired visual effects. In embodiments the system is capable of executing on standard computer hardware (e.g., that includes a graphical processing unit (GPU)). The system can therefore be implemented on normal desktop machines, intraoral scanning systems, server computing machines, mobile computing devices (e.g., such as a smart phone, laptop computer, tablet computer, etc.), and so forth.

In embodiments, a video processing pipeline is applied to images and/or frames of a video generated from a 3D head model to transform those images/frames from a current condition into an estimated future condition or other altered condition. Machine learning models such as neural networks may be trained for performing operations such as key point or landmark detection, segmentation, area of interest detection, fitting or registration, and/or synthetic image generation in the image processing pipeline. Embodiments enable patients to see what their smile will look like after treatment. Embodiments also enable modification of teeth of one or more individuals in images and/or frames of a video (e.g., of a movie) in any manner that is desired.

In some embodiments, because a generated video can show a patient's smile from various angles and sides, it provides a better understanding of the 3D shape and position changes to their teeth expected by treatment and/or other dentition alterations. Additionally, because the generated video can show a patient's post-treatment smile and/or other dentition alterations under various expressions, it provides a better understanding of how that patient's teeth will appear after treatment and/or after other changes.

Consumer smile simulations are simulated images or videos generated for consumers (e.g., patients) that show how the smiles of those consumers will look after some type of dental treatment (e.g., such as orthodontic treatment). Clinical smile simulations are generated simulated images or videos used by dental professionals (e.g., orthodontists, dentists, etc.) to make assessments on how a patient's smile will look after some type of dental treatment. For both consumer smile simulations and clinical smile simulations, a goal is to produce a mid-treatment or post-treatment realistic rendering of a patient's smile that may be used by a patient, potential patient and/or dental practitioner to view a treatment outcome. For both use cases, the general process of generating a simulated video showing a post-treatment smile includes generating a 3D head model of a patient's current head, generating a video of the patient's current smile from the 3D head model, simulating or generating a treatment plan for the patient that indicates post-treatment positions and orientations for teeth and gingiva, and converting data from the treatment plan back into a new simulated video showing the post-treatment smile. Embodiments generate smile videos showing future conditions of patient dentition in a manner that is temporally stable and consistent between frames of the video. This helps doctors to communicate treatment results to patients, and helps patients to visualize treatment results and make a decision on dental treatment. After a smile simulation video is generated, the patient and doctor can easily compare the current condition of the patient's dentition with the post-treatment condition of the dentition and make a treatment decision. Additionally, if there are different treatment options, then multiple post-treatment videos may be generated, one for each treatment option. The patient and doctor can then compare the different post-treatment videos to determine which treatment option is preferred. Additionally, for doctors and dental labs, embodiments help them to plan a treatment from both an aesthetic and functional point of view, as they can see the patient acting naturally in post-processed videos showing their new teeth. Embodiments also generate videos showing future conditions of other types of subjects based on videos of current conditions of the subjects.

Embodiments described herein provide significant advantages with respect to depicting dental treatment outcomes during various stages of a dental treatment. Such embodiments can provide systems and methods that register a 3D dentition model of a patient's current or altered dentition to a 3D head model to align the dentition with the patient's head so multiple images of the patient's head with the current or altered dentition can be generated and presented to the patient. The images can depict the patient's head and dentition in a variety of poses, positions, and at a variety of stages of the dental treatment process. Thus, embodiments described herein can accurately and realistically depict a patient's head and dentition at various stages of a dental treatment process. Accordingly, dental treatment efficacy is improved and optimized, and such improvements are likely to result in increased patient satisfaction.

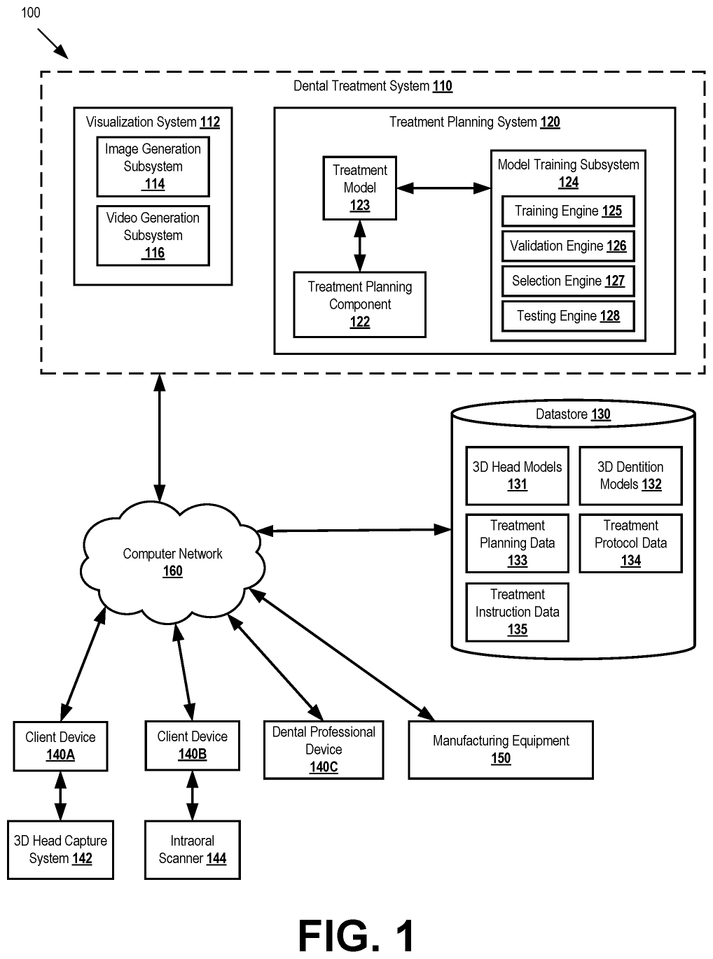

FIG. 1 is a schematic block diagram illustrating an example system 100 (e.g., an example system architecture) for generating realistic dental treatment images and/or videos using 3D facial models (also referred to herein as 3D head models) and 3D dental models (e.g., 3D models of upper and/or lower dental arches), according to some embodiments. The system 100 may include a dental treatment system 110, a datastore 130, one or more user devices 140, manufacturing equipment 150, and/or a computer network 160. The dental treatment system 110 may include a visualization system 112 and a treatment planning system 120. The visualization system 112 may include an image generation subsystem 114 and/or a video generation subsystem 116. The treatment planning system 120 may include a treatment planning component 122, a treatment model 123, and/or a model training subsystem 124 (which may include various components for training an AI model).

The dental treatment system 110 may include one or more computing devices. A computing device may include a rackmount server, a router computer, a server computer, a personal computer, a mainframe computer, a laptop computer, a tablet computer, a desktop computer, a graphics processing unit (GPU), an accelerator application-specific integrated circuit (ASIC) (e.g., a Tensor Processing Unit (TPU)), etc. One or more operations of the dental treatment system 110 may be performed by a cloud computing service, cloud data storage service, etc. Components of the dental treatment system 110 may include or be executed by one or more computing devices of the dental treatment system 110.

In one embodiment, the visualization system 112 may generate images and/or videos depicting images of patients'heads with current or altered dentitions. The altered dentitions may be determined by the treatment planning system 120, and may be reflected in a 3D dentition model of the patient's altered dentition. In some embodiments, the image generation subsystem 114 of the visualization system 112 may obtain 3D head models associated with patients, obtain current 3D dentition models associated with the respective patients, obtain altered 3D dentition models associated with the respective patients, and register the current and/or altered 3D dentition models to the respective 3D head models to align the 3D dentition models with one or more facial features of the 3D head models. The image generation subsystem 114 can then generate images of the 3D head models in various poses. The image generation subsystem 114 may additionally generate images of the altered 3D dentition in one or more poses corresponding to the various poses of the 3D head model based on registration information (e.g., transformation matrices) for registration of the current 3D dentition model to the 3D head model and pose information associated with the generated images of the 3D head models.

The image generation subsystem 114 may send the images of the patient head/face and the images of the altered dentition to the video generation subsystem 116. The video generation subsystem 116 may use the images depicting a patient's current head and the images of the altered dentition to generate modified images of the patient's current head in which the current dentition of the patient has been replaced with altered dentitions (e.g., dentitions during future stages of dental treatments or after dental treatment has been completed) of the patient. In embodiments, the modified images of the patient's head depict the patients'heads with altered dentition in a realistic and accurate manner. The video generation subsystem 116 can generate videos that includes the modified images. For example, each image may be used to generate a frame of the video. The video may show a patient's head (along with the patient's current or altered dentition) in various poses, positions, or from different angles. In embodiments, the frames of the video may be temporally stable in embodiments based on application of the techniques described in U.S. application Ser. No. 18/525,530, filed Nov. 30, 2023, which is incorporated by reference herein in its entirety.

In some embodiments, the treatment planning system 120 may include one or more components that plan a dental treatment for a patient. A dental treatment plan may include a plan for multi-stage orthodontic treatment. The dental treatment plan may include a plan for straightening a patient's teeth, correcting bite problems experienced by the patient, closing gaps between the patient's teeth, and/or aligning the patient's teeth and other oral anatomy of the patient. A dental treatment plan may include a restorative dental treatment. Examples of such restorative treatments include crowns, veneers, bridges, composite bonding, extractions, fillings, and so on. For example, a restorative treatment may include replacing an old crown with a new crown. A dental treatment plan may include disposing one or more dental appliances or hardware on the oral anatomy of the patient to achieve one or more dental outcomes. The treatment planning system 120 may include a treatment planning component 122. The treatment planning component 122 may receive treatment instruction data from a dental professional and use the dental instruction data to generate a dental treatment plan for a patient. In some embodiments, the treatment planning component 122 may use a treatment model 123 to assist in generating the dental treatment plan. The treatment model 123 may include an AI model trained and/or otherwise programmed to assist in generating a dental treatment plan.

By way of non-limiting example, a treatment outcome may be the result of a variety of dental procedures. Such dental procedures may be broadly divided into prosthodontic (restorative) and orthodontic procedures, and then further subdivided into specific forms of these procedures. Additionally, dental procedures may include identification and treatment of gum disease, sleep apnea, and intraoral conditions. The term prosthodontic procedure refers, inter alia, to any procedure involving the oral cavity and directed to the design, manufacture or installation of a dental prosthesis at a dental site within the oral cavity, or a real or virtual model thereof, or directed to the design and preparation of the dental site to receive such a prosthesis. A prosthesis may include any restoration such as implants, crowns, veneers, inlays, onlays, and bridges, for example, and any other artificial partial or complete denture. The term orthodontic procedure refers, inter alia, to any procedure involving the oral cavity and directed to the design, manufacture or installation of orthodontic elements at a dental site within the oral cavity, or a real or virtual model thereof, or directed to the design and preparation of the dental site to receive such orthodontic elements. These elements may be appliances including but not limited to brackets and wires, retainers, clear aligners, or functional appliances. Any of treatment outcomes or updates to treatment outcomes described herein may be based on these orthodontic and/or dental procedures. Examples of orthodontic treatments are treatments that reposition the teeth, treatments such as mandibular advancement that manipulate the lower jaw, treatments such as palatal expansion that widen the upper and/or lower palate, and so on. For example, an update to a treatment outcome may be generated by interaction with a user to perform one or more procedures to one or more portions of a patient's dental arch or mouth. Planning these orthodontic procedures and/or dental procedures may be facilitated by the AR system described herein.

A treatment plan for producing a particular treatment outcome may be generated by first generating an intraoral scan of a patient's oral cavity. From the intraoral scan a pre-treatment virtual 3D model of the upper and/or lower dental arches of the patient may be generated. A dental practitioner or technician may then determine a desired final position and orientation for the patient's teeth on the upper and lower dental arches, for the patient's bite, and so on. This information may be used to generate a post-treatment virtual 3D model of the patient's upper and/or lower arches after orthodontic and/or prosthodontic treatment. This data may be used to create an orthodontic treatment plan, a prosthodontic treatment plan (e.g., restorative treatment plan), and/or a combination thereof. An orthodontic treatment plan may include a sequence of orthodontic treatment stages. Each orthodontic treatment stage may adjust the patient's dentition by a prescribed amount, and may be associated with a 3D model of the patient's dental arch that shows the patient's dentition at that treatment stage.

A post-treatment 3D model or models of an estimated future condition of a patient's dental arch(es) may be shown to the patient. However, just viewing the post-treatment 3D model(s) of the dental arch(es) does not enable a patient to visualize what their face, mouth, smile, etc. will actually look like after treatment. Accordingly, in embodiments dental treatment system 110 generates a video that shows what the patient's face, smile, etc. will look like after treatment through multiple angles, views, expressions, etc.

In some embodiments, the various AI models discussed in connection with the treatment model 123 (e.g., a supervised machine learning model, an unsupervised machine learning model, etc.) may be combined in one model (e.g., a hierarchical model) or may be separate models. Data may be passed back and forth between several distinct models included in the treatment model 123 and the treatment planning component 122 or provided to a single model multiple times. In some embodiments, some or all of these operations may instead be performed by a different device, e.g., a server device (not shown in FIG. 1) of the dental treatment system 110, a user device 140, or some other computing device. It will be understood by one of ordinary skill in the art that variations in data flow, which components perform which processes, which models are provided with which data, and the like are within the scope of this disclosure.

AI models may perform many tasks, including generating a dental treatment plan, splitting an input up into related sections, formatting input text, detecting subject matter, transforming natural language instructions into machine-readable instructions, performing clinical checking, or the like. The treatment model 123 may be trained using dental instruction data. AI models may include machine learning models or other types of AI models.

One type of machine learning model that may be used to perform some or all of the above tasks is an artificial neural network, such as a deep neural network. Artificial neural networks generally include a feature representation component with a classifier or regression layers that map features to a desired output space. A convolutional neural network (CNN), for example, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g. classification outputs).

A recurrent neural network (RNN) is another type of machine learning model. A recurrent neural network model is designed to interpret a series of inputs where inputs are intrinsically related to one another, e.g., time trace data, sequential data, etc. Output of a perceptron of an RNN is fed back into the perceptron as input, to generate the next output. A graph convolutional network (GCN) is a type of machine learning model that is designed to operate on graph-structured data. Graph data includes nodes and edges connecting various nodes. GCNs extend CNNs to be applicable to graph-structured data which captures relationships between various data points. GCNs may be particularly applicable to meshes, such as three-dimensional data.

Many other types and varieties of machine learning models may be utilized for one or more embodiments of the present disclosure. Further types of machine learning models that may be utilized for one or more aspects include transformer-based architectures, generative adversarial networks, volumetric CNNs, etc. Selection of a specific type of machine learning model may be performed responsive to an intended input and/or output data, such as selecting a model adapted to 3D data to perform operations on 3D models of patients'heads, 3D models of patients'dentition, two-dimensional (2D) images of patients'dentition, etc.

Deep learning is a class of machine learning algorithms that use a cascade of multiple layers of nonlinear processing units for feature extraction and transformation. Each successive layer uses the output from the previous layer as input. Deep neural networks may learn in a supervised (e.g., classification) and/or unsupervised (e.g., pattern analysis) manner. Deep neural networks include a hierarchy of layers, where the different layers learn different levels of representations that correspond to different levels of abstraction. In deep learning, each level learns to transform its input data into a slightly more abstract and composite representation. In an image recognition application, for example, the raw input may be a matrix of pixels; the first representational layer may abstract the pixels and encode edges; the second layer may compose and encode arrangements of edges; the third layer may encode higher level shapes (e.g., teeth, lips, gums, etc.); and the fourth layer may recognize a scanning role. Notably, a deep learning process can learn which features to optimally place in which level on its own. The “deep” in “deep learning” refers to the number of layers through which the data is transformed. More precisely, deep learning systems have a substantial credit assignment path (CAP) depth. The CAP is the chain of transformations from input to output. CAPs describe potentially causal connections between input and output. For a feedforward neural network, the depth of the CAPs may be that of the network and may be the number of hidden layers plus one. For recurrent neural networks, in which a signal may propagate through a layer more than once, the CAP depth is potentially unlimited.

The treatment model 123 may include a large language model (LLM) configured via prompt engineering to perform one or more tasks based on treatment provider input. An LLM is a type of AI model designed to understand and generate human-like text, natural language, or the like. LLMs are generally built using deep learning techniques and trained on large datasets from diverse sources. LLMs often provide natural language understanding, text generation, contextual learning, instruction following based on nuanced or detailed prompts, and other functions. LLMs have advantages based on a large extent of knowledge mapped by the layers of the models, as well as an ability to make correct connections between concepts to generate relevant output. In some embodiments, an LLM may represent a single general-purpose or specifically trained or adjusted LLM, which may be utilized multiple times using different engineered prompts to perform various tasks in association with a set of doctor protocol description, instructions, input, etc.

In one embodiment, the treatment planning system 120 may include a model training subsystem 124. The model training subsystem 124 may include one or more components that train AI models. The model training subsystem 124 may include a training engine 125, a validation engine 126, a selection engine 127, and/or a testing engine 128. An engine (e.g., a training engine 125, a validation engine 126, a selection engine 127, and/or a testing engine 128) may refer to hardware (e.g., circuitry, dedicated logic, programmable logic, microcode, processing device, etc.), software (such as instructions run on a processing device, a general-purpose computer system, or a dedicated machine), firmware, microcode, or a combination thereof. The training engine 125 may be capable of training an AI model (e.g., the treatment model 123) using one or more sets of features associated with a training set from a data set generator. The training engine 125 may generate multiple trained AI models, where each trained AI model corresponds to a distinct set of features of the training set (e.g., instruction data from a specific subset of treatment categories, such as disorder types, treatment types, disorder severities, or another categorization). For example, a first trained model may have been trained using all features (e.g., X1-X5), a second trained model may have been trained using a first subset of the features (e.g., X1, X2, X4), and a third trained model may have been trained using a second subset of the features (e.g., X1, X3, X4, and X5) that may partially overlap the first subset of features. The data set generator may receive the output of a trained AI model (e.g., segmented input data into paragraphs each related with a target topic), collect that data into training, validation, and testing data sets, and use the data sets to train a second model (e.g., an AI model configured to perform further operations based on the segmented input data, etc.).

The validation engine 126 may be capable of validating a trained AI model using a corresponding set of features of a validation set from the data set generator. For example, a first trained AI model that was trained using a first set of features of the training set may be validated using the first set of features of the validation set. The validation engine 126 may determine an accuracy of each of the trained AI models based on the corresponding sets of features of the validation set. The validation engine 126 may discard trained AI models that have an accuracy that does not meet a threshold accuracy. In some embodiments, the selection engine 127 may be capable of selecting one or more trained AI models that have an accuracy that meets a threshold accuracy. In some embodiments, the selection engine 127 may be capable of selecting the trained AI model that has the highest accuracy of the trained AI models.

The testing engine 128 may be capable of testing a trained AI model using a corresponding set of features of a testing set from the data set generator. For example, a first trained AI model that was trained using a first set of features of the training set may be tested using the first set of features of the testing set. The testing engine 128 may determine a trained AI model that has the highest accuracy of all of the trained AI models based on the testing sets.

In the case of an AI model, the AI model may refer to the model artifact that is created by the training engine 125 using a training set that includes data inputs and corresponding target outputs (correct answers for respective training inputs). Patterns in the data sets can be found that map the data input to the target output (the correct answer), and the AI model is provided mappings that capture these patterns. The AI model may use one or more of Support Vector Machine (SVM), Radial Basis Function (RBF), clustering, supervised machine learning, semi-supervised machine learning, unsupervised machine learning, k-Nearest Neighbor algorithm (k-NN), linear regression, random forest, neural network (e.g., artificial neural network, recurrent neural network, CNN, graph neural network, GCN), etc.

In some embodiments, the datastore 130 may be a memory (e.g., random access memory), a drive (e.g., a hard drive, a flash drive), a database system, a cloud-accessible memory system, or another type of component or device capable of storing data. The datastore 130 may include multiple storage components (e.g., multiple drives or multiple databases) that may span multiple computing devices (e.g., multiple server computers). The datastore 130 may store various types of data, including 3D head models 131, 3D dentition models 132, treatment planning data 133, treatment protocol data 134, and/or treatment instruction data 135.

The 3D head models 131 may include 3D models of patients'heads. The 3D head models 131 may be based on one or more scans or images of patients'heads. Each 3D head model 131 of the 3D head models 131 may include a 3D data representation of an individual patient's head. In embodiments, the 3D head models are generated from a series of 2D images and/or 3D images, which may be taken by a patient device (e.g., a mobile phone of a patient) and/or a practitioner device (e.g., a 2D or 3D camera of a dental practitioner). The images may be stitched together to form a 3D head model of the patient's head in a current condition in embodiments.

The 3D dentition models 132 may include 3D models of patients'dentition, which may include a current dentition of a patient or may include an altered dentition of a patient. A 3D dentition model 132 that depicts a current dentition of the patient may be based on one or more scans (e.g., intraoral scans) of patient's dentition and/or one or more image of the patient's dentition (e.g., images captured by a patient device). A 3D dentition model 132 that depicts an altered dentition of the patient may include a modified version of the patient's current 3D dentition model 132. An altered dentition may include a dentition that is predicted to be the configuration of the patient's dentition at a point in time after the current dentition. For example, an altered dentition may include the patient's predicted dentition during a stage of a dental treatment plan or a final stage after the patient has undergone the dental treatment plan).

The treatment planning data 133 may be or include machine readable instructions or other data, e.g., related to target positions of one or more teeth to treat orthodontic disorders, related to treatment operations or steps for treating dental disorders, or the like. The treatment protocol data 134 may include data related to general plans meant to relate to one or more generic, common, repeatedly encountered, or the like healthcare disorders (e.g., dental disorders, malocclusion, misalignment, or the like). In some embodiments, the treatment planning system 120 may generate the treatment planning data 133 and/or the treatment protocol data 134 using unsupervised machine learning (e.g., the treatment planning data 133 and/or the treatment protocol data 134 includes output from the treatment model 123 that was trained using unlabeled data). In some embodiments, the treatment planning system 120 may generate the treatment planning data 133 and/or the treatment protocol data 134 using semi-supervised learning (e.g., training data may include a mix of labeled and unlabeled data, etc.). In some embodiments, the treatment planning system 120 may generate the treatment planning data 133 and/or treatment protocol data 134 using a rules-based system. Combinations of these techniques may also be used in embodiments.

In one embodiment, the treatment instruction data 135 may include instructions related to one or more treatment plans or treatment protocols. The treatment instruction data 135 may include dental professional comments, notes, or instructions related to treatment plans or treatment protocols. The treatment instruction data 135 may relate to natural language input by one or more dental professionals, doctors, orthodontists, healthcare professionals, treatment providers, practitioners, etc. The treatment instruction data 135 may include dental treatment plan manipulation data, which may include data that the treatment planning component may use to set up or modify a dental treatment plan for a patient. In some embodiments, the treatment planning component 122 of the treatment planning system 120 may obtain treatment instruction data 135, use at least some of the treatment instruction data 135 as input to the treatment model 123, and obtain outputs indicative of treatment plan data 133 and/or treatment protocol data 134 from the treatment model 123, which the treatment planning component 122 may store in the datastore 130.

In some embodiments, the client devices 140A-C may each include one or more computing devices. The client device 140A may include a device configured to obtain one or more scans of a patient's head from a 3D head capture system 142. The 3D head capture system 142 may include one or more image capture devices (e.g., video or photographic cameras) that capture images of a patient's head from different angles and/or positions. The image capture devices may include a 3D camera (e.g., a range camera or a stereo camera) capable of capturing images of the patient's head and determining distance points to locations in the images in order to generate 3D models of the patient's head in some embodiments. In some embodiments, the 3D head capture system 142 may include a mobile device used by the patient to capture the images of the patient's head. The client device 140A may obtain the one or more scans of the patient's head and may generate a 3D head model based on the scans, or the client device 140A may provide the one or more scans to another computing device (e.g., a computing device of the dental treatment system 110) configured to generate the 3D head model based on the scans. The 3D head model may be stored in the datastore 130 as part of the 3D head models 131.

In one embodiment, the client device 140B may include a device configured to obtain one or more scans of a patient's dentition from an intraoral scanner 144. The intraoral scanner 144 may include a handheld device equipped with one or more small cameras and/or optical sensors. One example of an intraoral scanner is the iTero® intraoral digital scanner manufactured by Align Technology, Inc. Another example of an intraoral scanner is set forth in U.S. Publication No. 2019/0388193, filed Jun. 19, 2019, which is incorporated by reference herein. A user may move the intraoral scanner 144 around the patient's mouth, capturing multiple 3D images or intraoral scans of the teeth and surrounding oral anatomy from various angles. In one embodiment, the client device 140B may stitch together the images or scans are to create a 3D dentition model of the patient's teeth and oral cavity. In some embodiments, the client device 140B may provide the one or more images or scans to another computing device (e.g., a computing device of the dental treatment system 110) configured to generate the 3D dentition model based on the scans and/or images. The 3D dentition model may be stored in the datastore 130 as part of the 3D dentition models 132.

During an intraoral scan session, an intraoral scan application receives and processes intraoral scan data (e.g., intraoral scans) and generates a 3D surface or model of a scanned region of an oral cavity (e.g., of a dental site) based on such processing. To generate the 3D surface, the intraoral scan application may register and “stitch” or merge together the intraoral scans generated from the intraoral scan session in real time or near-real time as the scanning is performed. Once scanning is complete, the intraoral scan application may then again register and stitch or merge together the intraoral scans using a more accurate and resource intensive sequence of operations. In one embodiment, performing registration includes capturing 3D data of various points of a surface in multiple scans (views from a camera), and registering the scans by computing transformations between the scans. The 3D data may be projected into a 3D space for the transformations and stitching. The scans may be integrated into a common reference frame by applying appropriate transformations to points of each registered scan and projecting each scan into the 3D space.

In one embodiment, registration is performed for adjacent or overlapping intraoral scans (e.g., each successive frame of an intraoral video). Registration algorithms are carried out to register two or more adjacent intraoral scans and/or to register an intraoral scan with an already generated 3D surface, which essentially involves determination of the transformations which align one scan with the other scan and/or with the 3D surface. Registration may involve identifying multiple points in each scan (e.g., point clouds) of a scan pair (or of a scan and the 3D model), surface fitting to the points, and using local searches around points to match points of the two scan (or of the scan and the 3D surface). For example, an intraoral scan application may match points of one scan with the closest points interpolated on the surface of another image, and iteratively minimize the distance between matched points. Other registration techniques may also be used. The intraoral scan application may repeat registration and stitching for all scans of a sequence of intraoral scans and update the 3D surface as the scans are received.

In one embodiment, the dental professional device 140C may include a computing device used by a dental professional to capture treatment instruction data 135 input by the dental professional and/or to output data to a dental professional. The treatment instruction data 135 may be provided via a graphical user interface (UI) of the dental professional device 140C. The treatment instruction data 135 may relate to one or more dental treatment plans, treatment protocols, or the like regarding a patient. Treatment instruction data 135 may relate to specific cases, e.g., dental treatment plans for a particular patient.

In some embodiments, the dental professional device 140C may be used by a dental professional to view or manipulate a dental treatment plan of a patient, submit prescriptions, or perform other dental treatment operations. The dental professional device 140C may receive images or videos from the visualization system 112 of the dental treatment system 110 and display the images or videos on a display of the dental professional device 140C. The dental professional device 140C may receive treatment planning data 133 or treatment protocol data 134 generated by the treatment planning system 120 and may display a visual representation of such data 134, 135 in order to obtain information about the dental treatment plan of a patient.

In embodiments, once a video of a patient's post treatment face, smile, head, etc. is generated, the video may be sent to and output by a display of dental professional device 140C and/or a client device 140A-B for viewing by an end user, such as a patient, doctor, technician, etc. In some embodiments, video generation is interactive. Dental treatment system 110 may receive one or more inputs (e.g., from an end user) to select changes to a target future condition of a subject's teeth, a pose of the patient's head, an expression, a degree to which the patient's mouth is open, a smile amount, and so on. Some examples of changes to dentition include adjusting a target tooth whiteness, adjusting a target position and/or orientation of one or more teeth, selecting alternative restorative treatment (e.g., selecting a composite vs. a metal filling), and so on. Based on such input, a treatment plan may be updated and/or a video of the patient's face, head, smile, etc. with the post-treatment dentition may be generated.

In one embodiment, the manufacturing equipment 150 may include one or more devices that manufacture appliances for performing treatment of a dental treatment plan. An appliance may include hardware or other devices that can be used to adjust tooth positions or other oral anatomy of a patient. Examples of appliances include orthodontic aligners, sleep apnea devices, retainers, mouth guards, and palatal expanders. The treatment planning system 120 may generate manufacturing data based on the treatment planning data 133 or the treatment protocol data 134, and the manufacturing data may be used for fabricating one or more appliances. Manufacturing operations may be initiated in response to the manufacturing equipment receiving the manufacturing data.

In some embodiments, the computer network 160 may include a public network or private network that provides access and data communication between one or more components of the system 100 and publicly and/or privately available computing devices. The computer network 160 may include one or more wide area networks (WANs), local area networks (LANs), wired networks (e.g., Ethernet network), wireless networks (e.g., an 802.11 network or a Wi-Fi network), cellular networks (e.g., a Long Term Evolution (LTE) network), routers, hubs, switches, server computers, cloud computing networks, and/or a combination thereof.

In some embodiments, the functions of the dental treatment system 110 may be provided by a fewer number of machines. For example, in some embodiments, the visualization system 112, the treatment planning system 120, and/or the datastore 130 may be integrated into a single machine or system. In some embodiments, the dental treatment system 110, the treatment planning system 120, the datastore 130, and/or the dental professional device 140C may be integrated into a single machine or system. In some embodiments, functions of the dental treatment system 110, the datastore 130, and/or the dental professional device 140C may be performed by a cloud-based service.

In general, functions described in one embodiment as being performed by the visualization system 112 can also be performed by the treatment planning system 120 in other embodiments, if appropriate. Some functions described as being performed by the visualization system 112 can also be performed by a computing device external from the dental treatment system 110 (e.g., a client device 140A-B, the dental professional device 140C, or a remote computing device in data communication with the system 100 via the computer network 160). In addition, the functionality attributed to a particular component can be performed by different or multiple components operating together. In addition, the functions of a particular component can be performed by different or multiple components operating together. The visualization system 112 or treatment planning system 120 may be accessed as a service provided to other systems or devices through appropriate application programming interfaces (API). In some embodiments, a “user” may be represented as a single individual. However, other embodiments of the disclosure encompass a “user” being an entity controlled by a plurality of users and/or an automated source. For example, a set of individual users federated as a group of administrators may be considered a “user.”

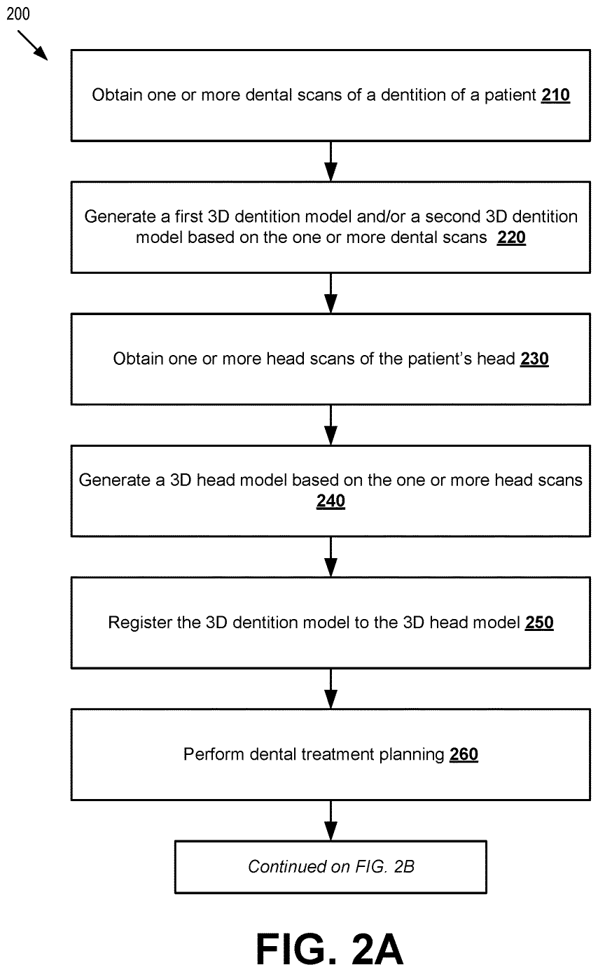

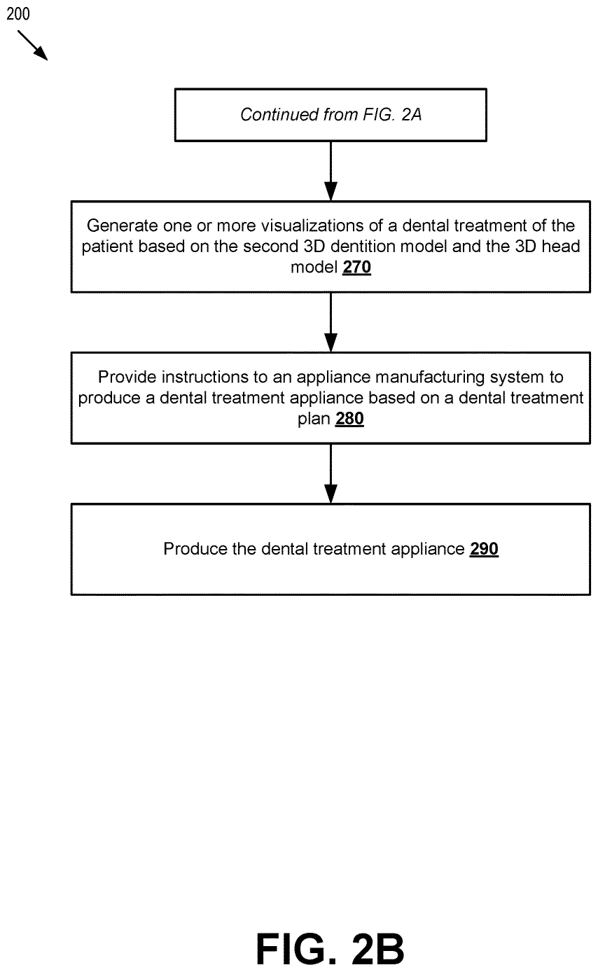

FIGS. 2A-B illustrate a flow diagram of a method 200 for performing a dental treatment and for generating realistic dental treatment images using 3D facial (or head) and dental models, in accordance with embodiments of the present disclosure. The method 200 may be performed by processing logic that comprises hardware (e.g., circuitry, dedicated logic, programmable logic, microcode, etc.), software (such as instructions run on a processing device), or a combination thereof. The method 200 may be performed by one or more components of the system 100 of FIG. 1.

At block 210, processing logic obtains one or more dental scans of a dentition of a patient. For example, the client device 140B may obtain one or more dental scans. The one or more dental scans may include intraoral scans performed by the intraoral scanner 144. The one or more dental scans may depict a current dentition of the patient. In one embodiment, the dental treatment system 110 may obtain the one or more dental scans (e.g., from the client device 140B over the computer network 160).

At block 220, processing logic generates a first 3D dentition model and/or a second 3D dentition model based on the one or more dental scans. The client device 140B may generate the 3D dentition model 132 by registering and stitching together a plurality of intraoral scans captured during an intraoral scanning session. In one embodiment, the dental treatment system 110 may take the first 3D dentition model as input and generate the second 3D dentition model, which may be a 3D dentition model of a post-treatment dentition and/or one or more additional 3D dentition models of intermediate stages of treatment. The 3D dentition model(s) 132 may be stored in the datastore 130. In some embodiments, the treatment plan and 3D dentition model(s) 132 have already been generated, and the 3D dentition models 132 are retrieved from datastore 130 rather than performing the operations of blocks 210-220.

At block 230, processing logic obtains one or more head scans of the patient's head. For example, the client device 140A may obtain one or more head scans. The one or more head scans may include scans of the patient's head (e.g., face) performed by the 3D head capture system 142. The one or more head scans may depict a current visual representation of the patient's head from different angles, positions, etc. In one embodiment, the dental treatment system 110 may obtain the one or more head scans (e.g., from the client device 140A over the computer network 160).

At block 240, processing logic generates a 3D head model based on the one or more head scans. The client device 140A may generate the 3D head model 131 based on the one or more head scans. In one embodiment, the dental treatment system 110 may generate the 3D head model 131. In embodiments, the 3D head capture system 142 and/or client device 140A registers and stitches together a plurality of scans of the patient's head, and generates a 3D head or face model 131 therefrom. The 3D head model 131 may be stored in the datastore 130. In some embodiments, the head model 131 is already generated, and is retrieved from datastore 130. In such embodiments, the operations of blocks 230-240 may be skipped.

At block 250, processing logic registers the first 3D dentition model to the 3D head model 131. Registering the first 3D dentition model 132 to the 3D head model 131 may include aligning the first 3D dentition model 132 with the 3D head model 131. The aligning process can include feature extraction from both the first 3D dentition model 132 and the 3D head model 131, to identify points, lines, and/or surfaces. These features may be matched between the first 3D dentition model 132 and the 3D head model 131 based on geometric or appearance-based similarities. Once matched, a transformation matrix can be generated and used to align the first 3D dentition model's 132 coordinate system with the 3D head model's 131 coordinate system. The transformation can involve rotation, translation, and/or scaling operations. Iterative optimization techniques may refine the transformation matrix and minimize an error between the projected first 3D dentition model 132 features and the corresponding 3D head model 131 features. Any suitable 3D to 3D registration algorithm can be used. The determined registration between the first 3D dentition model and the 3D head model may be applied to the second 3D dentition model in embodiments.

At block 260, processing logic may perform dental treatment planning. Alternatively, dental treatment planning may have already been performed. In some embodiments, dental treatment planning is performed at block 220 in order to generate the second 3D dentition model. In one embodiment, the dental professional device 140C may provide treatment instruction data 135 to the treatment planning component 122 of the treatment planning system 120. The treatment instruction data 135 may provide information about desired dental treatment for the patient. In some embodiments, the dental professional device 140C may cause the treatment planning component 122 to obtain additional data, such as the first 3D dentition model 132 associated with the patient, the one or more dental scans of the patient's dentition, or other data. The treatment planning component 122 may process the received data and may generate treatment planning data 133 that indicates a dental treatment plan for the patient. The treatment planning component 122 may use the trained treatment model 123 to assist in generating the treatment plan data 133 in some embodiments.

At block 270, processing logic generates one or more visualizations of a dental treatment of the patient based on the second 3D dentition model and the 3D head model 131. The positions of one or more teeth may differ between the first 3D dentition model and the second 3D dentition model 132 in embodiments. The image generation subsystem 114 may use the 3D head model 131 and the second 3D dentition model 132 as input and may generate one or more altered images of the 3D head model that include the altered dentition reflected in the second 3D dentition model in embodiments. Because the 3D head model 131 and the 3D dentition models 132 are aligned due to the registration at block 250, the one or more generated images depict the teeth of the patient aligned with the patient's head in a realistic manner. Furthermore, the patient's head can appear in different poses or positions. The video generation subsystem 116 can compile the one or more images into a video, and the video can be transmitted to a computing device of the patient, a dental professional, or another party, and viewed thereon. After viewing the video and/or images showing the patients head and/or smile with the patient's post-treatment dentition, the patient may decide to proceed with treatment. At this stage, the doctor may finish the treatment plan and order one or more dental appliances.

At block 280, processing logic provides instructions to an appliance manufacturing system to produce a dental treatment appliance (or series of dental treatment appliances) based on the dental treatment plan. The appliance manufacturing system may include the manufacturing equipment 150 of FIG. 1. The dental treatment appliance may include an aligner, a retainer, braces, or other components that shift the positions of a patient's oral anatomy. The dental treatment plan may include a result of the dental treatment planning of block 260. The instructions can be configured to control a fabrication system or device that produces the dental treatment appliance(s) and/or one or more molds that may be used to form the dental treatment appliances (e.g., by performing thermoforming of a polymer sheet around the mold(s) and then trimming the thermoformed polymer sheet based on trimming instructions (e.g., which may be included in the treatment plan).

At block 290, processing logic produces the dental treatment device. Producing the dental treatment device may include the manufacturing equipment producing the dental treatment appliance and/or the mold, and may include thermoforming the dental treatment appliance around the mold and then performing trimming, as mentioned above. In some embodiments, the production of the dental treatment appliance may include direct fabrication (e.g., stereolithography, selective laser sintering, fused deposition modeling, 3D printing, continuous direct fabrication, multi-material direct fabrication, etc.). In some embodiments, the production includes indirect fabrication of the appliance, e.g., by direct 3D printing of the mold, and then thermoforming a plastic sheet over the mold.

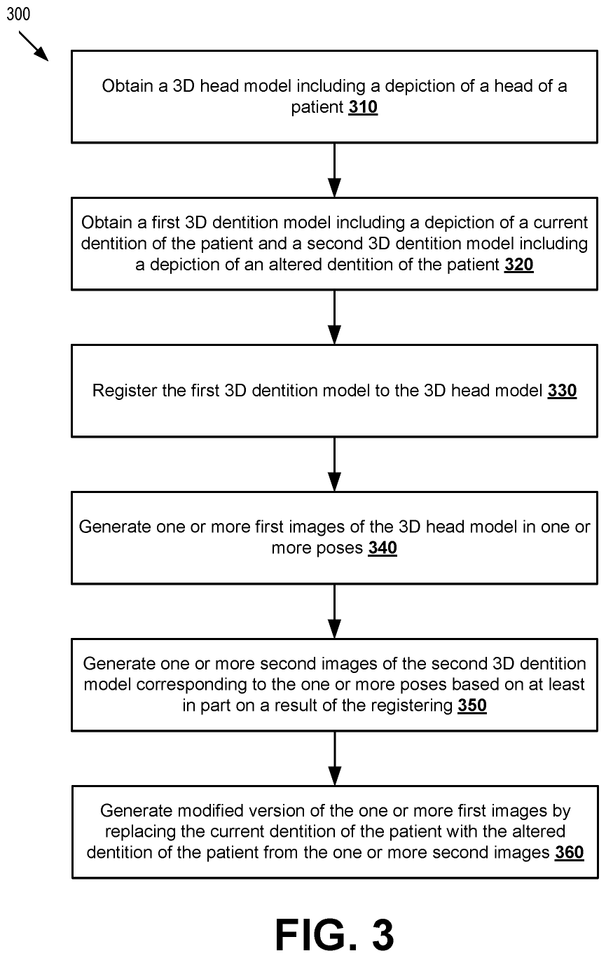

FIG. 3 illustrates a flow diagram of a method 300 for generating realistic dental treatment images and/or video using 3D facial and dental models, in accordance with embodiments of the present disclosure. The method 300 may be performed by processing logic that comprises hardware (e.g., circuitry, dedicated logic, programmable logic, microcode, etc.), software (such as instructions run on a processing device), or a combination thereof. The method 300 may be performed by one or more components of the system 100 of FIG. 1. For example, the visualization system 112 (including the image generation subsystem 114 and/or the video generation subsystem 116) may perform one or more operations of the method 300.

At block 310, processing logic obtains a 3D head model 131. The 3D head model 131 may include a depiction of a current head of a patient. Obtaining the 3D head model 131 may include the visualization system 112 of FIG. 1 obtaining the 3D head model 131 from the datastore 130 or from the client device 140A. The 3D head model 131 may have been generated from one or more head scans performed by the 3D head capture system 142.

At block 320, processing logic obtains a first 3D dentition model 132. The first 3D dentition model 132 may include a depiction of a current dentition of the patient. A current dentition of the patient may include an initial dentition of the patient, for example, the dentition of the patient prior to undergoing a dental treatment plan. Processing logic may obtain a second 3D dentition model 132. The second 3D dentition model 132 may include a depiction of an altered dentition of the patient. An altered dentition of the patient may include a planned future condition of a dentition of the patient during a dental treatment process or after completion of the dental treatment process. In some embodiments, the treatment planning system 120 may alter a copy of the first 3D dentition model 132 based on information from the dental treatment plan associated with the patient to generate the second 3D dentition model 132. Obtaining the first 3D dentition model 132 and/or the second 3D dentition model 132 may include the visualization system 112 obtaining the first and/or second 3D dentition models 132 from the datastore 130 or from the client device 140B that is associated with the intraoral scanner 144.

At block 330, processing logic registers the first 3D dentition model 132 to the 3D head model 131. Operations of block 330 may be similar to operations of block 250 of the method 200 of FIG. 2, discussed above. For example, block 330 may include aligning the first 3D dentition model 132 with the 3D head model 131, and the aligning can include feature extraction, feature matching, using a transformation matrix, etc.

At block 340, processing logic generates one or more first images of the 3D head model 131 in one or more poses. In one embodiment, the image generation subsystem 114 may generate the one or more first images. A pose of the 3D head model 131 may include the 3D head model 131 being positioned at a certain angle. A pose may include the 3D head model 131 being positioned at a certain distance from a viewing point. The pose may additionally include other information such as a degree or wideness of smile, an amount of shown teeth, a facial expression, and so on in some embodiments.

In some embodiments, the one or more poses may be determined based on input data. The input data may include input data to the visualization system 112. The input data may include a rotation direction of the 3D head model 131. The rotation direction may indicate a direction in which the 3D head model 131 can rotate in a 3D space. The input data may include a rotation speed of the 3D head model 131. The input data may include a zoom setting of the 3D head model 131. The zoom setting may indicate a distance from a viewing point to a point on the 3D head model 131. The input data may include an angle of the 3D head model 131. The angle may indicate an angular position of the 3D head model 131 in a 3D space. The one or more poses may include a profile (e.g., side) view of the 3D head model 131 in embodiments. Any of these parameters may be selected based on user manipulation of the 3D head model 131 (e.g., based on interaction with one or more UI controls).

The input data may include user selection data. User selection data may include data based on input provided by a user of the visualization system 112. For example, a user may select one or more UI elements of a UI associated with the visualization system 112, and the selected UI element may indicate input data based on the user's selection(s). For example, the user may use a scroll bar to select a value for the zoom setting. The user may use a mouse to rotate the 3D head model in a 3D space, and the position the user arrives at may be indicated by an angle value. In some embodiments, the input data may include position data indicating a real-time position of the head of a patient. For example, the patient may be using the 3D head capture system 142 to perform head scans of the patient, and the 3D head capture system may provide input data indicating real-time position information indicating how the patient's head is positioned at the current time.

The one or more first images of the 3D head model 131 may include multiple images of the 3D head model 131, and each image may include the 3D head model 131 in a different pose. As an example, a first image may include the 3D head model 131 facing to the left, a second image may include the 3D head model 131 facing the front, and a third image may include the 3D head model 131 facing to the right.

At block 350, processing logic generates one or more second images of the second 3D dentition model 132 (e.g., the 3D dentition model 132 that includes a depiction of an altered dentition of the patient) corresponding to the one or more poses based at least in part on a result of the registering. In some embodiments, the image generation subsystem 114 may generate the one or more second images.

The visualization system 112 may generate a second image for at least some images of the one or more first images of block 340, and each second image may correspond to (e.g., have a same pose, orientation, zoom setting, etc.) as a corresponding first image. Continuing the above example, a first image may include the second 3D dentition model 132 facing to the left, a second image may include the second 3D dentition model 132 facing the viewing point, and a third image may include the second 3D dentition model 132 facing to the right. The respective position of the second 3D dentition model 132 in each of the one or more second images may match the position of the 3D head model 131 in the corresponding first image such that the respective second 3D dentition model 132 aligns with the 3D head model 131. The visualization system 112 can derive the position data for the second 3D dentition model 132 because of the registering of the first 3D dentition model to the 3D head model at block 330. In one embodiment, one or more transformation matrices may be generated based on the registering of the first 3D dentition model 132 to the 3D head model 131. The one or more transformation matrices and the one or more poses may be used to generate the one or more second images in embodiments.

At block 360, processing logic generates modified versions of the one or more first images by replacing the current dentition of the patient with the altered dentition of the patient from the one or more second images. In some embodiments, the video generation subsystem 116 may perform at least a portion of block 360. Replacing the current dentition of the patient in a first image with the altered dentition depicted in a corresponding second image may include superimposing the depiction of the altered dentition from the corresponding second image on a dental area of the patient's head in the corresponding first image. The patient's head in the first image is aligned with the altered dentition in the second image due to the registering.

In some embodiments, the video generation subsystem 116 may use one or more trained AI models to perform landmark detection, area of interest detection (e.g., inner mouth area detection), segmentation, feature extraction, modified frame generation, etc. to help position the altered dentition from a second image on a mouth area of the corresponding first image. The one or more AI models may perform tasks such as:
I) Dental object segmentation—this can include performing point-level classification (e.g., pixel-level classification or voxel-level classification) of different types and/or instances of dental objects from frames of a video and/or from a 3D model of a dental arch. The different types of dental objects may include, for example, teeth, gingiva, an upper palate, a preparation tooth, a restorative object other than a preparation tooth, an implant, a tongue, a bracket, an attachment to a tooth, soft tissue, a retraction cord (dental wire), blood, saliva, and so on. In some embodiments, images and/or 3D models of teeth and/or a dental arch are segmented into individual teeth, and optionally into gingiva.
II) Landmark detection—this can include identifying landmarks in images. The landmarks may be particular types of features, such as centers of teeth in embodiments. In some embodiments, landmark detection is performed before or after dental object segmentation. In some embodiments, these facial landmarks can be used to estimate the orientation of the facial skull and therefore the upper jaw. In some embodiments, dental object segmentation and landmark detection are performed together by a single AI model. In one embodiment, one or more stacked hourglass networks are used to perform landmark detection. One example of a model that may be used to perform landmark detection is a convolutional neural network that includes multiple stacked hourglass models, as described in Alejandro Newell et al., Stacked Hourglass Networks for Human Pose Estimation, Jul. 26, 2016, which is incorporated by reference herein in its entirety.
III) Teeth boundary prediction—this can include using one or more trained AI models to predict teeth boundaries and/or boundaries of other dental objects (e.g., mouth parts) optionally accompanied by depth estimation based on an input of one or more frames of a video. Teeth boundary prediction may be used instead of or in addition to landmark detection and/or segmentation in embodiments.
IV) Frame interpolation—this can include generating (e.g., interpolating) simulated frames that show teeth, gums, etc. as they might look between those teeth, gums, etc. in frames at hand. Such interpolated frames may be photo-realistic images. In some embodiments, a generative model such as a generative adversarial network (GAN), encoder/decoder model, diffusion model, variational autoencoder (VAE), neural radiance field (NeRF), etc. is used to generate intermediate simulated frames. In one embodiment, a generative model is used that determines features of two input frames in a feature space, determines an optical flow between the features of the two frames in the feature space, and then uses the optical flow and one or both of the frames to generate a simulated frame. In one embodiment, a trained AI model that determines frame interpolation for large motion is used, such as is described in Fitsum Reda at al., FILM: Frame Interpolation for Large Motion, Proceedings of the European Conference On Computer Vision (ECC) (2022), which is incorporated by reference herein in its entirety.
V) Frame generation—this can include generating estimated frames (e.g., 2D images) of how a patient's teeth are expected to look at a future stage of treatment (e.g., at an intermediate stage of treatment and/or after treatment is completed). Such frames may be photo-realistic images. In embodiments, a generative model (e.g., such as a GAN, encoder/decoder model, etc.) operates on extracted image features of a current frame and a 2D projection of a 3D model of a future state of the patient's dental arch to generate a simulated or modified frame.
VI) Optical flow determination—this can include using a trained AI model to predict or estimate optical flow between frames. Such a trained AI model may be used to make any of the optical flow determinations described herein.
VII) Jaw orientation (pose) detection—this can include using a trained AI model to estimate the orientation of an upper jaw and/or a lower jaw of an individual in an image. In some embodiments, processing logic estimates a pose of a face, where the pose of the face may correlate to an orientation of the upper jaw. The pose and/or orientation of the upper and/or lower jaw may be determined, for example, based on identified landmarks. In some embodiments, jaw orientation and/or pose detection is performed together with dental object segmentation and/or landmark detection by a single AI model.

By modifying each first image depicting the 3D head model 131 using the properly positioned altered dentition from the corresponding second image depicting a 3D dentition model 132, the video generation subsystem 116 can generate a series of images depicting the patient's head in various poses with an altered dentition of the patient properly aligned and positioned regarding the patient's head. As discussed further below, the video generation subsystem 116 may compile the series of images into a video that can be viewed by the patient or a dental professional.

One type of machine learning model that may be used to perform some or all of the above tasks is an artificial neural network, such as a deep neural network. Artificial neural networks generally include a feature representation component with a classifier or regression layers that map features to a desired output space. A convolutional neural network (CNN), for example, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g. classification outputs). Deep learning is a class of machine learning algorithms that use a cascade of multiple layers of nonlinear processing units for feature extraction and transformation. Each successive layer uses the output from the previous layer as input. Deep neural networks may learn in a supervised (e.g., classification) and/or unsupervised (e.g., pattern analysis) manner. Deep neural networks include a hierarchy of layers, where the different layers learn different levels of representations that correspond to different levels of abstraction. In deep learning, each level learns to transform its input data into a slightly more abstract and composite representation. In an image recognition application, for example, the raw input may be a matrix of pixels; the first representational layer may abstract the pixels and encode edges; the second layer may compose and encode arrangements of edges; the third layer may encode higher level shapes (e.g., teeth, lips, gums, etc.); and the fourth layer may recognize a scanning role. Notably, a deep learning process can learn which features to optimally place in which level on its own. The “deep” in “deep learning” refers to the number of layers through which the data is transformed. More precisely, deep learning systems have a substantial credit assignment path (CAP) depth. The CAP is the chain of transformations from input to output. CAPs describe potentially causal connections between input and output. For a feedforward neural network, the depth of the CAPs may be that of the network and may be the number of hidden layers plus one. For recurrent neural networks, in which a signal may propagate through a layer more than once, the CAP depth is potentially unlimited.

In one embodiment, a generative model is used for one or more machine learning models. The generative model may be a generative adversarial network (GAN), encoder/decoder model, diffusion model, variational autoencoder (VAE), neural radiance field (NeRF), or other type of generative model. The generative model may be used, for example, in modified frame generator 336.

A GAN is a class of artificial intelligence system that uses two artificial neural networks contesting with each other in a zero-sum game framework. The GAN includes a first artificial neural network that generates candidates and a second artificial neural network that evaluates the generated candidates. The GAN learns to map from a latent space to a particular data distribution of interest (a data distribution of changes to input images that are indistinguishable from photographs to the human eye), while the discriminative network discriminates between instances from a training dataset and candidates produced by the generator. The generative model's training objective is to increase the error rate of the discriminative network (e.g., to fool the discriminator network by producing novel synthesized instances that appear to have come from the training dataset). The generative model and the discriminator network are co-trained, and the generative model learns to generate images that are increasingly more difficult for the discriminative network to distinguish from real images (from the training dataset) while the discriminative network at the same time learns to be better able to distinguish between synthesized images and images from the training dataset. The two networks of the GAN are trained once they reach equilibrium. The GAN may include a generator network that generates artificial intraoral images and a discriminator network that attempts to differentiate between real images and artificial intraoral images. In embodiments, the discriminator network may be a MobileNet.

In embodiments, the generative model is trained to perform frame interpolation—synthesizing intermediate images between a pair of input frames or images. The generative model may receive a pair of input frames, and generate an intermediate frame that can be placed in a video between the pair of frames, such as for frame rate upscaling. In one embodiment, the generative model has three main stages, including a shared feature extraction stage, a scale-agnostic motion estimation stage, and a fusion stage that outputs a resulting color image. The motion estimation stage in embodiments is capable of handling a time-wise non-regular input data stream. Feature extraction may include determining a set of features of each of the input images in a feature space, and the scale-agnostic motion estimation may include determining an optical flow between the features of the two images in the feature space. The optical flow and data from one or both of the images may then be used to generate the intermediate image in the fusion stage. The generative model may be capable of stable tracking of features without artifacts for large motion. The generative model may handle disocclusions in embodiments. Additionally the generative model may provide improved image sharpness as compared to traditional techniques for image interpolation. In embodiments, the generative model generates simulated images recursively. The number of recursions may not be fixed, and may instead be based on metrics computed from the images.

In some embodiments, an AI model such as a trained neural network is trained to perform landmark detection to identify features or sets of features (e.g., landmarks) on each frame of a video. Landmark detection may be performed on frames individually or together. In some embodiments, a current frame, a previous frame, and/or landmarks determined from a previous frame are input into the trained machine learning model, which outputs landmarks for the current frame. In one embodiment, identified landmarks are one or more teeth, centers of one or more teeth, eyes, nose, and so on. The detected landmarks may include facial landmarks and/or dental landmarks in embodiments. An output of landmark detection may include information on the locations (e.g., coordinates) of each of multiple different features or landmarks in an input frame. Groups of landmarks may indicate a pose (e.g., position, orientation, etc.) of a head, a chin or lower jaw, an upper jaw, one or more dental arch, and so on in embodiments. In embodiments, the facial landmarks are used to determine a six-dimensional (6D) pose of the face based on the facial landmarks and a 3D face model (e.g., by performing fitting between the facial landmarks and a general 3D face model. Processing logic may then determine a relative position of the upper dental arch of the individual to a frame at least in part on the 6D pose.

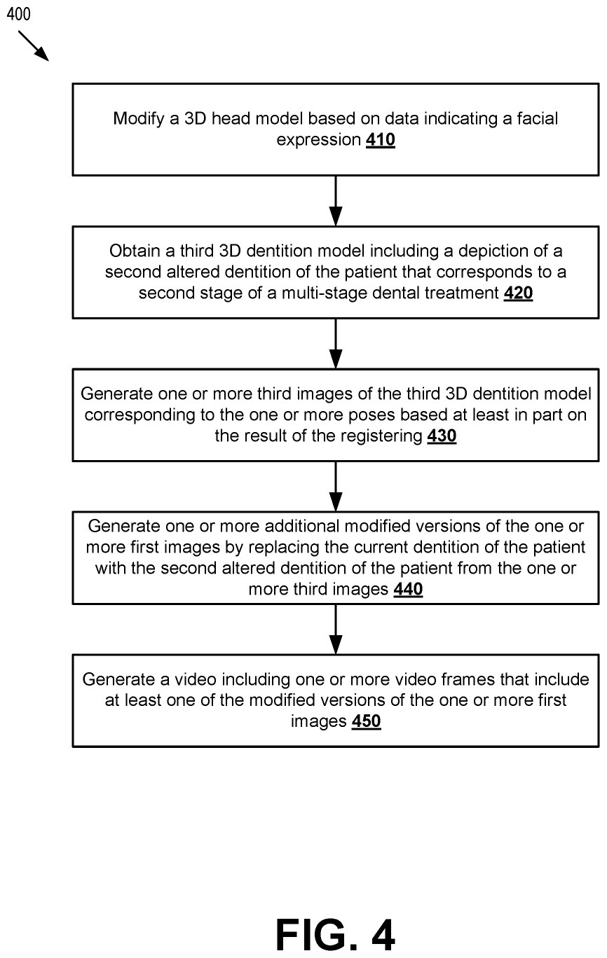

FIG. 4 illustrates a flow diagram of a method 400 for generating realistic dental treatment images using 3D facial and dental models, in accordance with embodiments of the present disclosure. The method 400 may be performed by processing logic that comprises hardware (e.g., circuitry, dedicated logic, programmable logic, microcode, etc.), software (such as instructions run on a processing device), or a combination thereof. The method 400 may be performed by one or more components of the system 100 of FIG. 1. For example, the visualization system 112 (including the image generation subsystem 114 and/or the video generation subsystem 116) may perform one or more operations of the method 400. In some embodiments, one or more operations of method 300 are performed for method 400.

At block 410, processing logic may modify the 3D head model 131 based on data indicating a facial expression. The image generation subsystem 114 may perform block 410. In one embodiment, input data may indicate one or more facial expressions. The facial expression may include movement of one or more portions of the 3D head model 131 that corresponds to soft tissue of the patient's head. The one or more soft tissue portions may include a lip, a cheek, an area around an eye, a nose, or other facial portions. The facial expression may include a neutral expression, a smile, an open mouth, or some other facial expression. The image generation subsystem 114 may generate the one or more first images of the 3D head model 131 with the facial expression in block 340 of the method 300 of FIG. 3. Different first images may depict different facial expressions.

At block 420, processing logic may obtain a third 3D dentition model 132. The third 3D dentition model 132 may include a depiction of a second altered dentition image of the patient that corresponds to a second stage of a multi-stage dental treatment plan. The second stage of the dental treatment plan may include an intermediate stage (e.g., a stage that is not the final stage of the dental treatment plan) in some embodiments. The image generation subsystem 114 may perform block 420.

In some embodiments, the treatment planning system 120 may alter the first 3D dentition model 132 based on information from the dental treatment plan to generate the third 3D dentition model 132. Obtaining the third 3D dentition model 132 may include the visualization system 112 obtaining the third 3D dentition model 132 from the datastore 130. In one embodiment, the altered dentition of the second 3D dentition model 132 of block 320 may include a final result of the dental treatment plan, and the second altered dentition of the third 3D dentition model 132 may include an intermediate result of the dental treatment plan.

At block 430, processing logic may generate one or more third images of the third 3D dentition model 132 corresponding to the one or more poses based at least in part on the result of the registering of block 330 of the method 300. The image generation subsystem 114 may perform block 430. The visualization system 112 may generate a third image for at least some images of the one or more first images of block 340, and each third image may correspond to a first image. Block 430 may include functionality similar to the functionality of block 350.

At block 440, processing logic may generate one or more additional modified versions of the one or more first images by replacing the current dentition of the patient with the second altered dentition of the patient from the one or more third images and/or by updating the 3D head model based on the inputs provided at block 410. In some embodiments, the video generation subsystem 116 may perform at least a portion of block 440. Replacing the current dentition of the patient in a first image with the second altered dentition depicted in a corresponding third image may include superimposing the second altered dentition on a dental area of the patient's head. The patient's head in the first image is aligned with the second altered dentition due to the registering of block 330. In some embodiments, the video generation subsystem 116 may use one or more trained AI models to perform landmark detection, area of interest detection (e.g., inner mouth area detection), segmentation, feature extraction, modified frame generation, etc. to help position the altered dentition from a third image on a mouth area of the corresponding first image.

At block 450, processing logic generates a video. The video may include one or more video frames. Each video frame may include at least one of the modified versions of the one or more first images. In some embodiments, the video shows progression of the patient's dentition through different stages of treatment. In some embodiments, the video shows changing facial expressions. In some embodiments, the video shows changes in head pose. In some embodiments, the video shows a combination of a progression of dental treatment, changes in head pose, and/or changes in facial expression. The video generation subsystem 116 may generate the video. In some embodiments, the visualization system 112 may cause the video to be presented on a client device 140A-B, the dental professional device 140C, or another computing device so the patient or a dental professional can view the video and see a depiction of a future dentition of the patient based on the dental treatment plan.

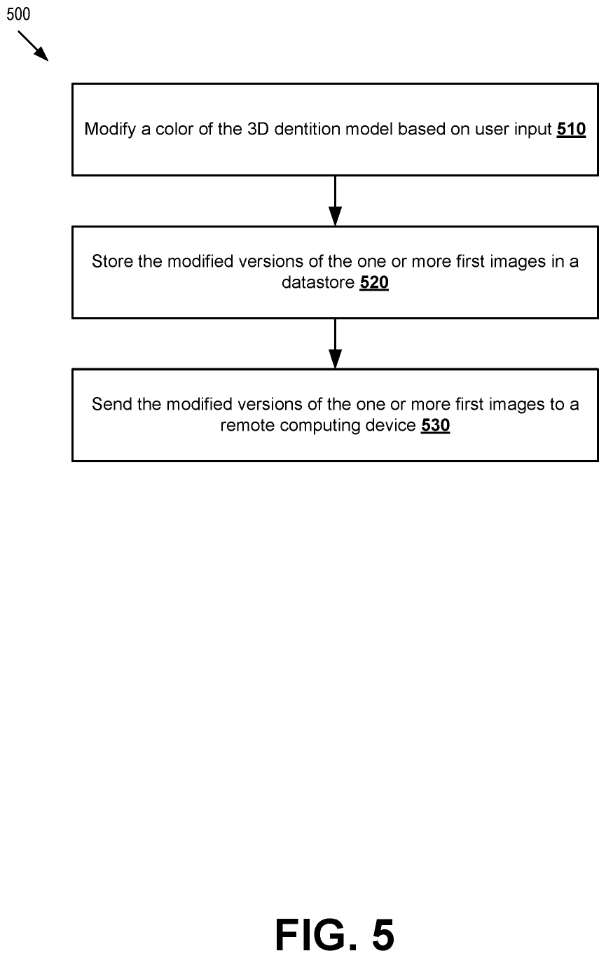

FIG. 5 illustrates a flow diagram of a method 500 for generating realistic dental treatment images and/or video using 3D facial and dental models, in accordance with embodiments of the present disclosure. The method 500 may be performed by processing logic that comprises hardware (e.g., circuitry, dedicated logic, programmable logic, microcode, etc.), software (such as instructions run on a processing device), or a combination thereof. The method 500 may be performed by one or more components of the system 100 of FIG. 1. For example, the visualization system 112 (including the image generation subsystem 114 and/or the video generation subsystem 116) may perform one or more operations of the method 500.

At block 510, processing logic modifies a color of a 3D dentition model 132. Modification to the color may include, for example, bleaching the teeth or increasing a brightness or whiteness of the teeth. In some embodiments, the image generation subsystem 114 may modify the color of the 3D dentition model 132. The 3D dentition model 132 may include the first 3D dentition model 132 (e.g., based on initial scans of the patient's dentition) or a second 3D dentition model 132 (e.g., a 3D dentition model 132 based on a later stage of the dental treatment plan). Modifying the color of the 3D dentition model 132 may cause the dentition depicted in the modified versions of the one or first images to appear similar to the teeth color of the patient, or to whitened teeth of the patient in embodiments. The modification of the color may be based on user input. For example, the user input may indicate a color for the patient's teeth.

At block 520, processing logic stores the modified versions of the one or more first images in a datastore. The datastore may include the datastore 130 of FIG. 1. For example, the video generation subsystem 116 may provide the modified versions of the one or more first images to the datastore 130. In one embodiment, the video generation subsystem 116 may retrieve some of the modified versions of the one or more first images from the datastore 130 to generate a video depicting the modified versions of the one or more first images.

At block 530, processing logic sends the modified versions of the one or more first images to a remote computing device. The remote computing device may include a client device 140A-B, the dental professional device 140C, or another computing device. In one embodiment, the client device 140A may retrieve some of the modified versions of the one or more first images from the datastore 130 to present on a UI of the client device 140A in order to present the modified versions of the one or more first images to a patient. In some embodiments, the dental professional device 140C may retrieve some of the modified versions of the one or more first images from the datastore 130 to present on a UI of the dental professional device 140C in order to present the modified versions of the one or more first images to a patient or dental professional. In one embodiment, a remote computing device may retrieve some of the modified versions of the one or more first images from the datastore 130. The remove computing device may include the video generation subsystem 116, and the video generation subsystem 116 may use the modified versions of the one or more first images to generate a video that includes the modified images.

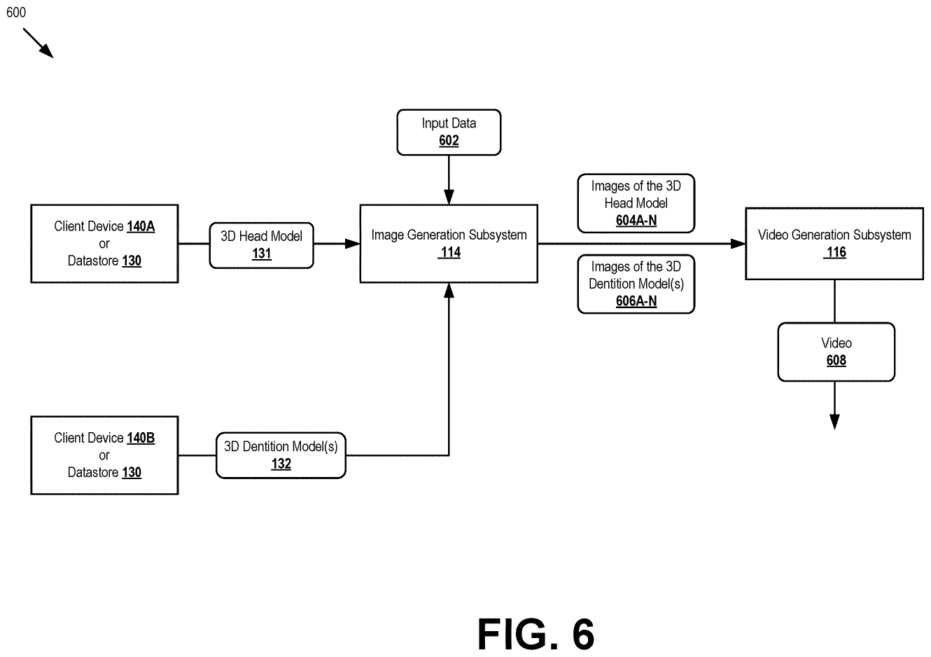

FIG. 6 illustrates a workflow 600 for generating realistic dental treatment images and/or video using 3D facial and dental models, in accordance with an embodiment of the present disclosure. In embodiments, the workflow 600 may be performed by the visualization system 112. The workflow 600 may be performed by processing logic executed by a processor of a computing device. For example, the visualization system 112 (including the image generation subsystem 114 and/or the video generation subsystem 116) may perform one or more operations of the workflow 600.

A 3D head model 131 may be provided to the image generation subsystem 114 of the visualization system 112 of the dental treatment system 110 of FIG. 1. The 3D head model 131 may be provided by the client device 140A of FIG. 1. The 3D head model 131 may be provided by the datastore 130 of FIG. 1. For example, as discussed above, the client device 140A may obtain one or more head scans using the 3D head capture system 142, generate the 3D head model 131 based on the head scans, and may store the 3D head model 131 in the datastore 130.

One or more 3D dentition models 132 may be provided to the image generation subsystem 114. The 3D dentition model(s) 132 may include the first 3D dentition model 132 that includes a depiction of the current dentition of the patient. The 3D dentition model(s) 132 may include the second 3D dentition model 132 that includes a depiction of an altered dentition of the patient. The first 3D dentition model 132 may be provided by the client device 140B. The first and/or second 3D dentition model 132 may be provided by the datastore 130. For example, as discussed above, the client device 140B may obtain one or more dentition scans using the intraoral scanner 144, generate the first 3D dentition model 132 based on the dentition scans, store the first 3D dentition model 132 in the datastore 130, and the treatment planning system 120 of FIG. 1 may generate the second 3D dentition model 132 based on treatment planning data 133 associated with the patient.

In some embodiments, the image generation subsystem 114 may receive input data 602. As discussed above, the input data 602 may include data that can indicate a rotation direction of the 3D head model 131, a rotation speed of the 3D head model 131, a zoom setting of the 3D head model 131, or an angle of the 3D head model 131. The input data 602 may include data indicating one or more poses for the 3D head model 131. The input data 602 may include data indicating one or more facial expressions for the 3D head model 131. The input data 602 may include data indicating to modify the color of a 3D dentition model 132. The input data 602 may include a progression or sequence of updates to the head pose, facial expression, and so on, which may be used to generate a temporal sequence of images in embodiments.

The image generation subsystem 114 may register the first 3D dentition model 132 to the 3D head model 131, as discussed above. The image generation subsystem 114 may generate one or more (e.g., a temporal sequence of) first images of the 3D head model 604A-N in one or more poses (e.g., which may include head direction, head angle, facial expression, zoom setting, and so on). The poses may be indicated by the input data 602. The image generation subsystem 114 may generate one or more second images of the second 3D dentition model 606A-N corresponding to the one or more poses and based at least in part on a result of registering of the 3D head model to a first 3D dentition model that shows a patient's current dentition. As discussed above, each image of the 3D head model 604 may correspond to an image of the 3D dentition model 606. For example, image 604A may correspond to image 606A, image 604B may correspond to 606B, image 604C may correspond to image 606C, and so on.

The image generation subsystem 114 may provide the one or more first images of the 3D head model 604A-N and the one or more second images of the 3D dentition model(s) 606A-N to the video generation subsystem 116. The video generation subsystem 116 may generate modified versions of the one or more first images 604A-N by replacing the current dentition of the patient with the altered dentition of the patient from the one or more second images 606A-N, as discussed above. The video generation subsystem 116 may generate a video 608. The video 608 may include one or more video frames, and each video frame may include at least one of the modified versions of the one or more first images 604A-N. The video 608 can then be presented on a client device 140A-B, the dental professional device 140C, or another computing device so the patient or a dental professional can view the video and see a depiction of a future dentition of the patient based on the dental treatment plan. In embodiments, video generation subsystem 116 performs one or more operations described in U.S. patent application Ser. No. 18/525,530, filed Nov. 30, 2023, to perform video generation.

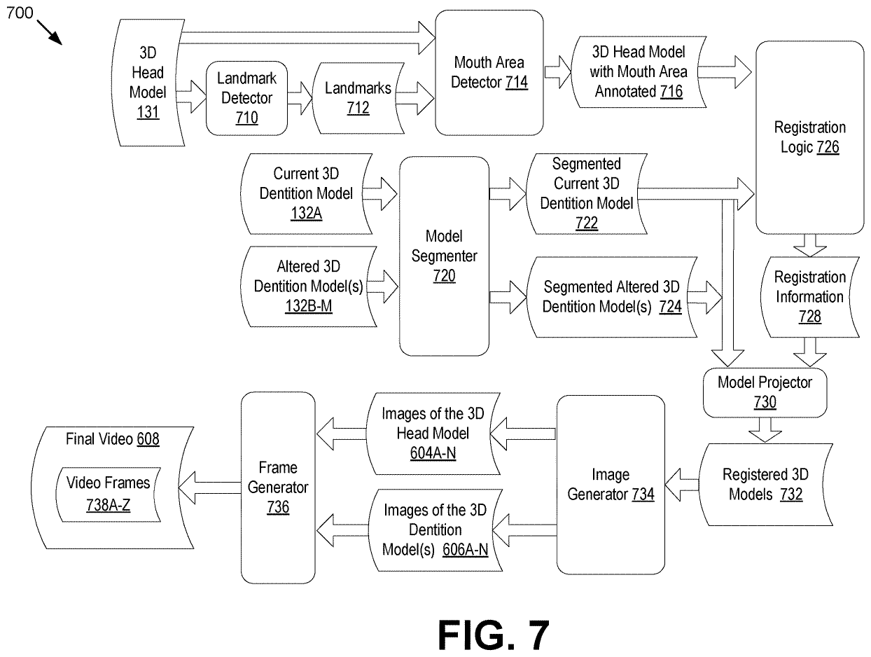

FIG. 7 illustrates a workflow 700 for generating realistic dental treatment images using 3D facial and dental models, in accordance with an embodiment of the present disclosure. In embodiments, the workflow 700 may be performed by the visualization system 112. The workflow 700 may be performed by processing logic executed by a processor of a computing device. For example, the visualization system 112 (including the image generation subsystem 114 and/or the video generation subsystem 116) may perform one or more operations of the workflow 700.

One stage of the workflow 700 is landmark detection. Landmark detection includes using a trained AI model (e.g., such as a deep neural network) that has been trained to identify features or sets of features (e.g., landmarks) on the 3D head model 131. In at least one embodiment, the 3D head model 131 is input into a landmark detector 710. The landmark detector 710 may generate data based on the 3D head model 131 and input the data into a trained AI model, which outputs landmarks 712 for the 3D head model 131. In one embodiment, identified landmarks 712 are one or more teeth, centers of one or more teeth, eyes, nose, and so on. The detected landmarks 712 may include facial landmarks and/or dental landmarks. The landmark detector 710 may output information on the locations (e.g., coordinates) of each of multiple different features or landmarks 712 of the 3D head model 131. Groups of landmarks 712 may indicate a pose (e.g., position, orientation, etc.) of a head, a chin or lower jaw, an upper jaw, one or more dental arch, and so on in embodiments. In at least one embodiment, the facial landmarks 712 are used to determine a six-dimensional (6D) pose of the face based on the facial landmarks 712 and a facial portion of the 3D head model 131 (e.g., by performing fitting between the facial landmarks 712 and the 3D head model 131).

Once landmark detection is performed, the 3D head model 131 and at least some of the landmarks 712 may be input into a mouth area detector 714. The mouth area detector 714 may include a trained AI model that processes a 3D head model 131 and/or landmarks 712 to determine a mouth area within the 3D head model 131. Alternatively, the mouth area detector 714 may not include an AI model and may determine a mouth area using the landmarks 712 and one or more simple heuristics (e.g., that define a bounding box around facial landmarks 712 for lips).

In at least one embodiment, the mouth area detector 714 may detect a bounding region (e.g., a bounding box) around a mouth area of the 3D head model 131. The bounding region may include one or more offset around a detected mouth area. Accordingly, in one or more embodiments the bounding region may include lips, a portion of cheek, a portion of a chin, a portion of a nose, and so on. Alternatively, the bounding region may not be rectangular in shape, and/or may trace the lips so as to include only the mouth area. In at least one embodiment, landmark detection and mouth area detection are performed by the same AI model. The mouth area detector 714 may output the 3D head model with the mouth area annotated 716.

In one embodiment, the mouth area detector 714 may detect an area of interest that is smaller than a mouth region. For example, the mouth area detector 714 may detect an area of a dental site within a mouth area. The area of the dental site may be, for example, a limited area or one or more teeth that will undergo restorative treatment. Examples of such restorative treatments include crowns, veneers, bridges, composite bonding, extractions, fillings, and so on. For example, a restorative treatment may include replacing an old crown with a new crown. For such an example, the mouth area detector 714 may identify an area of interest associated with the region of the old crown.

In some embodiments, the 3D head model is segmented. Alternatively, the 3D head model may not be segmented. In embodiments, a current 3D dentition model 132A and one or more altered 3D dentition models 132B-M may be processed by a model segmenter 720. The model segmenter 720 may segment the 3D models 132A-M to identify and label each individual tooth in the 3D models 132A-M and gingiva in the 3D models 132A-M. In at least one embodiment, the model segmenter 720 segments the 3D models 132A-M and outputs segmented current 3D dentition model 722 and one or more segmented altered 3D dentition models 724. The segmented current 3D dentition model 722 may then be input into registration logic 726, along with the 3D head model with the mouth area annotated 716.

The registration logic 726 can perform registration and fitting between the 3D head model with the mouth area annotated 716 and the segmented current 3D dentition model 722. In at least one embodiment, a rigid fitting algorithm is used to find a 6D orientation (e.g., including translation along three axes and rotation about three axes) in space for both the upper and lower teeth. In at least one embodiment, the fitting is performed between the face in the 3D head model with the mouth area annotated 716 and a common face mesh (which may be scaled to a current face). This enables processing logic to determine where the face is positioned in 3D space, which can be used as a constraint for fitting of the segmented current 3D dentition model 722 to the 3D head model with the mouth area annotated 716. After completing face fitting, teeth fitting (e.g., fitting of the dental arches to the frame) may be performed between the upper and lower dental arches and the frame. The fitting of the face mesh to the 3D head model with the mouth area annotated 716 may be used to impose one or more constraints on the teeth fitting in some embodiments.

The registration logic 726 may output registration information 728. The registration information 328 may include an orientation, position and/or zoom setting (e.g., 6D fitting parameters) of the segmented current 3D dentition model 722 to the 3D head model with mouth area annotated 716. The registration information 728 may be input into a model projector 730 along with segmented altered 3D dentition models 724. The model projector 730 may then project the segmented current 3D dentition models 722 and/or one or more of the segmented altered 3D dentition models 724 to the 3D head model with mouth area annotated 716 using the received registration information 728 to produce registered 3D models 732. In at least one embodiment, the model projector 730 additionally determines normals to the 3D surfaces of the teeth, gums, etc. from the segmented 3D dentition models 722, 724. Each normal may be a 3D vector that is normal to a surface of the segmented 3D dentition models 722, 724 at a given pixel as projected onto the 3D head model with mouth area annotated 716. In at least one embodiment, a normal map that includes normals to surfaces of the segmented 3D dentition models 722, 724 may be generated. The normal map may be a 3D map that includes one of more of the normals. In one embodiment, the 3D map comprises a red, green, blue (RGB) image, wherein one or more pixels of the RGB image comprise a red value representing a component of a vector along a first axis, a green value representing a component of the vector along a second axis, and a blue value representing a component of the vector along a third axis.

In one embodiment, an image generator 734 may receive the registered 3D models 732, including the 3D head model and the second 3D dentition model including the altered dentition. For each indicated pose from input data (e.g., input data 602), which may include a stream of input data, a pose may be determined. For each pose, the image generator 734 may project each the 3D head model and the second 3D dentition model 732 onto a 2D plane associated with the pose to generate a respective 2D image of the head model and a respective 2D image of the second 3D dentition model. The 2D images may include a temporal sequence of the images of the 3D head model 604A-N and the corresponding images of the second 3D dentition model 606A-N. The images 604A-N, 606A-N may be provided to a frame generator 736.

In at least one embodiment, the frame generator 736 may generate modified versions of the images of the 3D head model 604A-N by disposing the corresponding images of the altered 3D dentition models 606A-N on the mouth areas of the images of the 3D head model 604A-N. As discussed above, because the images of the 3D head model 604A-N and the corresponding images of the altered 3D dentition models 606A-N are registered (and were generated with the same pose), the images of the altered 3D dentition models 606A-N are properly positioned such that they can be disposed on the mouth areas of the corresponding images of the 3D head model 604A-N and be correctly aligned and sized.

In one embodiment, the frame generator 736 may include an AI model trained and/or otherwise configured to receive a pair of input images and perform image interpolation, e.g., synthesizing intermediate images between a pair of input images. The AI model may include a generative model. The generative model may receive a pair of input images and generate an intermediate video frame that can be placed in a video between a pair of video frames, such as for frame rate upscaling. In one embodiment, the generative model may have three main stages, including a shared feature extraction stage, a scale-agnostic motion estimation stage, and a fusion stage that can output a resulting color image. The motion estimation stage, in some embodiments, may be capable of handling a time-wise non-regular input data stream. Feature extraction may include determining a set of features of each of the input images in a feature space, and the scale-agnostic motion estimation may include determining an optical flow between the features of the two images in the feature space. The optical flow and data from one or both of the images may then be used to generate the intermediate image in the fusion stage. The generative model may be capable of stable tracking of features without artifacts for large motion. The generative model may handle disocclusions in embodiments. In one embodiment, the generative model may provide improved image sharpness as compared to traditional techniques for image interpolation. In at least one embodiment, the generative model can generate simulated images recursively. The number of recursions may not be fixed and may instead be based on metrics computed from the images.

In one embodiment, the AI model may include a conditional generative adversarial (cGAN) network, such as pix2pix or vid2vid. These networks not only learn the mapping from input image to output image, but also learn a loss function to train this mapping. GANs are generative models that learn a mapping from random noise vector z to output image y,G:z→y. In contrast, conditional GANs learn a mapping from observed image x and random noise vector z, to y,G:{x,z} →y. The generator G is trained to produce outputs that cannot be distinguished from “real” images by an adversarially trained discriminator, D, which is trained to do as well as possible at detecting the generator's “fakes”. The generator may include a U-net or encoder-decoder architecture in embodiments. The discriminator may include a MobileNet architecture in embodiments. An example of a cGAN machine learning architecture that may be used is the pix2pix architecture described in Isola, Phillip, et al. “Image-to-image translation with conditional adversarial networks.” arXiv preprint (2017).

The frame generator 736 may output a video 608, which may include one or more video frames 738A-Z. Each video frame 738A-Z may include an image of the 3D head model 131 with either an image of the current dentition of the patient or an altered dentition of the patient disposed on the mouth area of the 3D head model 131. Each frame may be based on a corresponding pair of the images of the 3D head model 604A-N and the images of the 3D dentition model(s) 606A-N or an interpolated image generated by the AI model of the frame generator 736, as discussed above.

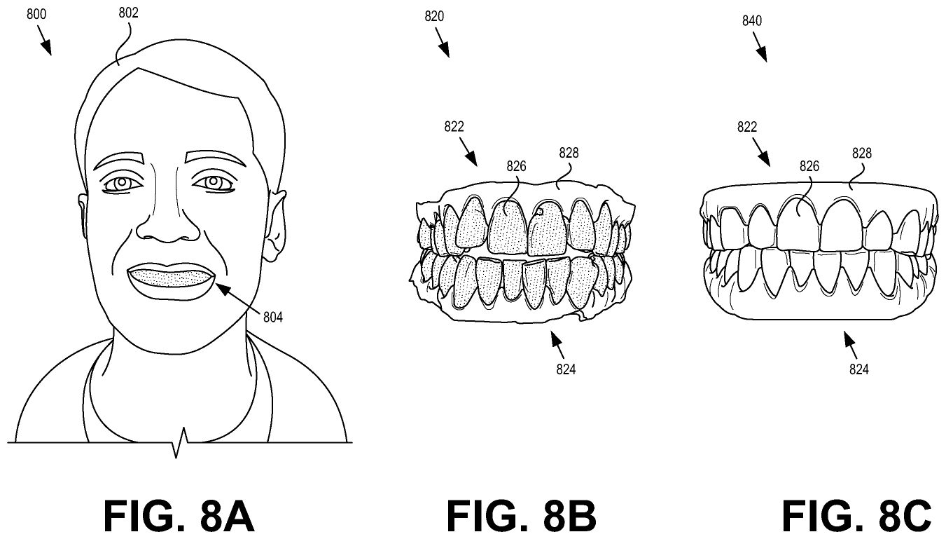

FIG. 8A illustrates an example 3D head model 800, in accordance with some embodiments of the present disclosure. The 3D head model 800 may include the 3D head model 131. As can be seen in FIG. 8A, the 3D head model 800 may include a geometry 802 that forms the shape and/or structure of the 3D head model 800. The geometry 802 may include polygons, textures, or other components of 3D models. The geometry 802 may be shaped, sized, and colored to depict the head of the patient depicted by the model. For example, the geometry 802 may include head anatomy such as hair, skin, ears, a nose, eyes, a neck, etc. The 3D head model 800 may include a mouth area 804. The mouth area 804 may include an area of the 3D head model 800 that corresponds to the mouth of the patient. The mouth area 804 may depict oral anatomy of the patient (e.g., teeth, gingiva, etc.), or, as seen in FIG. 8A, the mouth area 804 may not depict the patient's oral anatomy.

FIG. 8B illustrates an example current 3D dentition model 820, in accordance with some embodiments of the present disclosure. The current 3D dentition model 820 may include the first 3D dentition model 132 that depicts a current dentition of the patient. As seen in FIG. 8B, the current 3D dentition model 820 may include an upper dental arch 822 and/or a lower dental arch 824. The current 3D dentition model 820 may include one or more teeth 826 and gingiva 828.

FIG. 8C illustrates an example altered 3D dentition model 840, in accordance with some embodiments of the present disclosure. The altered 3D dentition model 840 may include a second 3D dentition model 132 that depicts an altered dentition of the patient (e.g., a dentition of the patient based on a future stage of a dental treatment plan). As seen in FIG. 8C, the altered 3D dentition model 840, like the current 3D dentition model 820 of FIG. 8B, may include an upper dental arch 822, a lower dental arch 824, one or more teeth 826 and/or gingiva 828. One or more of the teeth 826 may be in different positions from the teeth 826 of FIG. 8C due the dental treatment plan.

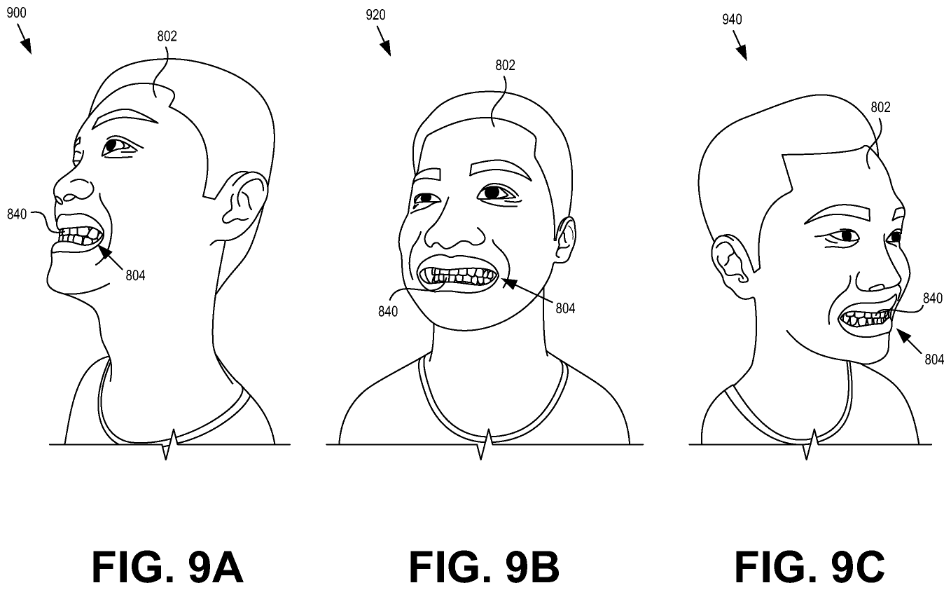

FIGS. 9A-C illustrate example modified images 900, 920, 940 of a 3D head model 800 in various poses, in accordance with some embodiments of the present disclosure. The example modified images 900, 920, 940 may include a depiction of the 3D head model 800 and an altered 3D dentition model 840. The modified images 900, 920, 940 may include the geometry 802 of the 3D head model 800 (e.g., hair, nose, eyes, etc.). The modified images 900, 920, 940 may include the mouth area 804 of the 3D head model 800. The modified images 900, 920, 940 may include the altered 3D dentition model 840 disposed in the mouth area 804. As can be seen from FIGS. 9A-C, due to the registration of the 3D dentition model 132 to the 3D head model 131, the altered 3D dentition model 840 is sized, shaped, and positioned to properly align with the 3D head model 800 in each image 900, 920, 940.

The images 900, 920, 940 depict the 3D head model 800 and the altered 3D dentition model 840 in various poses. For example, in the image 900 of FIG. 9A, the pose includes a profile view of the 3D head model 800. In the image 920 of FIG. 9B, the pose includes the 3D head model 800 rotated to the viewer's right. In the image 940 of FIG. 9C, the pose includes the 3D head model 800 rotated further to the viewer's right. The video generation subsystem 116 may use the images 900, 920, 940 to generate video frames 738 of a video 608. The frame generator 736 of the video generation subsystem 116 may use pairs of the images 900, 920, 940 as pairs of input images to perform image interpolation to generate further video frames 738 for the video 608, as discussed above.

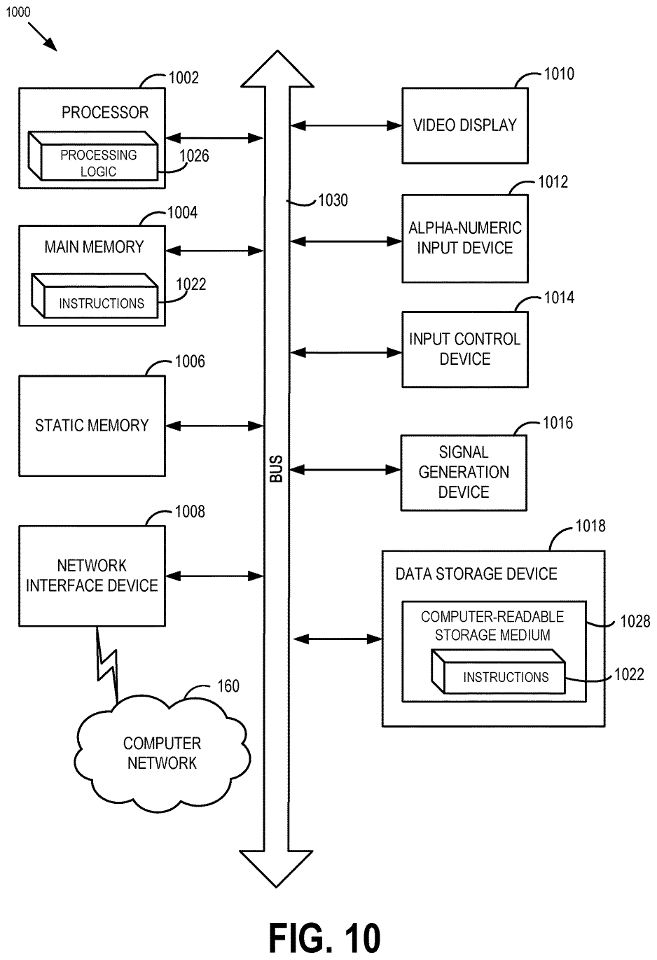

FIG. 10 illustrates a block diagram of an example processing device 1000 operating in accordance with one or more aspects of the present disclosure. In one implementation, the processing device 1000 can be a part of any computing device of FIG. 1, or any combination thereof. Example processing device 1000 can be connected to other processing devices in a LAN, an intranet, an extranet, and/or the Internet. The processing device 1000 can be a personal computer (PC), a set-top box (STB), a server, a network router, switch or bridge, or any device capable of executing a set of instructions (sequential or otherwise) that specify actions to be taken by that device. Further, while only a single example processing device is illustrated, the term “processing device” shall also be taken to include any collection of processing devices (e.g., computers) that individually or jointly execute a set (or multiple sets) of instructions to perform any one or more of the methods discussed herein.

The example processing device 1000 can include a processor 1002 (e.g., a CPU), a main memory 1004 (e.g., read-only memory (ROM), flash memory, dynamic random access memory (DRAM) such as synchronous DRAM (SDRAM), etc.), a static memory 1006 (e.g., flash memory, static random access memory (SRAM), etc.), and a secondary memory (e.g., a data storage device 1018), which can communicate with each other via a bus 1030.

The processor 1002 may represent one or more general-purpose processing devices such as a microprocessor, central processing unit, or the like. More particularly, the processor 1002 can be a complex instruction set computing (CISC) microprocessor, reduced instruction set computing (RISC) microprocessor, very long instruction word (VLIW) microprocessor, processor implementing other instruction sets, or processors implementing a combination of instruction sets. The processor 1002 can also be one or more special-purpose processing devices such as an application specific integrated circuit (ASIC), a field programmable gate array (FPGA), a digital signal processor (DSP), network processor, or the like. In accordance with one or more aspects of the present disclosure, the processor 1002 can be configured to execute instructions (e.g. the processing logic 1026 can implement the visualization system 112, the image generation subsystem 114, the video generation subsystem 116, the treatment planning system 120, or other components discussed herein).

The example processing device 1000 can further include a network interface device 1008, which can be communicatively coupled to the computer network 160. The example processing device 1000 can further include a video display 1010 (e.g., a liquid crystal display (LCD), a touch screen, or a cathode ray tube (CRT)), an alphanumeric input device 1012 (e.g., a keyboard), an input control device 1014 (e.g., a cursor control device, a touch-screen control device, a mouse), and a signal generation device 1016 (e.g., an acoustic speaker).

The data storage device 1018 can include a computer-readable storage medium (or, more specifically, a non-transitory computer-readable storage medium) 1028 on which is stored one or more sets of executable instructions 1022. In accordance with one or more aspects of the present disclosure, executable instructions 1022 can comprise executable instructions (e.g. instructions for implementing the visualization system 112, the image generation subsystem 114, the video generation subsystem 116, the treatment planning system 120, or other components discussed herein or for implemented one or more of the methods 200, 300, 400, or 500).

The executable instructions 1022 can also reside, completely or at least partially, within the main memory 1004 and/or within the processor 1002 during execution thereof by the example processing device 1000, the main memory 1004, and the processor 1002 also constituting computer-readable storage media. The executable instructions 1022 can further be transmitted or received over a network (e.g., the computer network 160) via network interface device 1008.

While the computer-readable storage medium 1028 is shown in FIG. 10 as a single medium, the term “computer-readable storage medium” should be taken to include a single medium or multiple media (e.g., a centralized or distributed database, and/or associated caches and servers) that store the one or more sets of operating instructions. The term “computer-readable storage medium” shall also be taken to include any medium that is capable of storing or encoding a set of instructions for execution by the machine that cause the machine to perform any one or more of the methods described herein. The term “computer-readable storage medium” shall accordingly be taken to include, but not be limited to, solid-state memories, and optical and magnetic media.

Some examples have been described with reference to dental treatment plans that include a series of stages that are each associated with a different orthodontic aligner. It should be understood that any such examples described with reference to dental treatment and a series of orthodontic aligners also applies to palatal expansion treatment and a series of palatal expanders. For palatal expansion treatment, a similar process may be performed as described above for orthodontic treatment. For example, an upper and/or lower dental arch and upper palate may be scanned using an intraoral scanner 144 to generate a 3D dentition model 132 of the dental arch(es) and of the upper palate. A final shape (e.g., width) of the upper palate may be determined, and a series of treatment stages to progress from a current upper palate shape and a final target upper palate shape may be determined. For each treatment stage, a polymeric palatal expander may be fabricated by the manufacturing equipment 150, either via direct fabrication (e.g., direct 3D printing) or by 3D printing of a mold and thermoforming a palatal expander over the mold. Materials used for palatal expanders may be the same as or different from those used for orthodontic aligners in embodiments.

Any of the methods (including user interfaces) described herein can be implemented as software, hardware or firmware, and can be described as a non-transitory machine-readable storage medium storing a set of instructions capable of being executed by a processor (e.g., computer, tablet, smartphone, etc.), that when executed by the processor causes the processor to control perform any of the steps, including but not limited to: displaying, communicating with the user, analyzing, modifying parameters (including timing, frequency, intensity, etc.), determining, alerting, or the like. For example, computer models (e.g., for additive manufacturing) and instructions related to forming a dental device can be stored on a non-transitory machine-readable storage medium.

It should be understood that the above description is intended to be illustrative, and not restrictive. Many other embodiment examples will be apparent to those of skill in the art upon reading and understanding the above description. Although the present disclosure describes specific examples, it will be recognized that the systems and methods of the present disclosure are not limited to the examples described herein but can be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

The embodiments of methods, hardware, software, firmware, or code set forth above can be implemented via instructions or code stored on a machine-accessible, machine readable, computer accessible, or computer readable medium which are executable by a processing element. “Memory” includes any mechanism that provides (i.e., stores and/or transmits) information in a form readable by a machine, such as a computer or electronic system. For example, “memory” includes random-access memory (RAM), such as static RAM (SRAM) or dynamic RAM (DRAM); ROM; magnetic or optical storage medium; flash memory devices; electrical storage devices; optical storage devices; acoustical storage devices, and any type of tangible machine-readable medium suitable for storing or transmitting electronic instructions or information in a form readable by a machine (e.g., a computer).

Reference throughout this specification to “one embodiment” or “an embodiment” means that a particular feature, structure, or characteristic described in connection with the embodiment is included in at least one embodiment of the disclosure. Thus, the appearances of the phrases “in one embodiment” or “in an embodiment” in various places throughout this specification are not necessarily all referring to the same embodiment. Furthermore, the particular features, structures, or characteristics can be combined in any suitable manner in one or more embodiments.

In the foregoing specification, a detailed description has been given with reference to specific exemplary embodiments. It will, however, be evident that various modifications and changes can be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment, embodiment, and/or other exemplarily language does not necessarily refer to the same embodiment or the same example, but can refer to different and distinct embodiments, as well as potentially the same embodiment.

The words “example” or “exemplary” are used herein to mean serving as an example, instance, or illustration. Any aspect or design described herein as “example′ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an embodiment” or “one embodiment” throughout is not intended to mean the same embodiment or embodiment unless described as such. Also, the terms “first,” “second,” “third,” “fourth,” etc. as used herein are meant as labels to distinguish among different elements and can not necessarily have an ordinal meaning according to their numerical designation.

A digital computer program, which can also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a digital computing environment. The essential elements of a digital computer a central processing unit for performing or executing instructions and one or more memory devices for storing instructions and digital data. The central processing unit and the memory can be supplemented by, or incorporated in, special purpose logic circuitry or quantum simulators. Generally, a digital computer will also include-or be operatively coupled to receive digital data from or transfer digital data to, or both-one or more mass storage devices for storing digital data, e.g., magnetic, magneto-optical disks, optical disks, or systems suitable for storing information. However, a digital computer need not have such devices.

Digital computer-readable media suitable for storing digital computer program instructions and digital data include all forms of non-volatile digital memory, media, and memory devices, including by way of example semiconductor memory devices, e.g., EPROM, EEPROM, and flash memory devices; magnetic disks, e.g., internal hard disks or removable disks; magneto-optical disks; CD-ROM and DVD-ROM disks.

Control of the various systems described in this specification, or portions of them, can be implemented in a digital computer program product that includes instructions that are stored on one or more non-transitory machine-readable storage media, and that are executable on one or more digital processing devices. The systems described in this specification, or portions of them, can each be implemented as an apparatus, method, or system that can include one or more digital processing devices and memory to store executable instructions to perform the operations described in this specification.

While this specification contains many specific embodiment details, these should not be construed as limitations on the scope of what can be claimed, but rather as descriptions of features that can be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system modules and components in the embodiments described above should not be understood as requiring such separation in all embodiments, and it should be understood that the described program components and systems can generally be integrated together in a single software product or packaged into multiple software products.

Certain example implementations are provided below.

A first example implementation includes a method comprising: obtaining a three-dimensional (3D) head model comprising a depiction of a current head of a patient, wherein the 3D head model comprises a representation of at least a portion of a current dentition of the patient; obtaining a first 3D dentition model comprising a depiction of the current dentition of the patient and a second 3D dentition model comprising a depiction of an altered dentition of the patient; registering the first 3D dentition model to the 3D head model; generating one or more first images of the 3D head model in one or more poses; generating one or more second images of the second 3D dentition model corresponding to the one or more poses based at least in part on a result of the registering; and generating modified versions of the one or more first images by replacing the current dentition of the patient with the altered dentition of the patient from the one or more second images, wherein the modified versions of the one or more first images are photorealistic.

A second example implementation may extend the first example implementation. In the second example implementation, one or more transformation matrices are generated based on the registering of the first 3D dentition model to the 3D head model, and wherein the one or more transformation matrices and the one or more poses are used to generate the one or more second images.

A third example implementation may extend any of the first through second example implementations. In the third example implementation, the method further comprises generating a video comprising a plurality of video frames, wherein each video frame of the plurality of video frames comprises at least one of the modified versions of the one or more first images.

A fourth example implementation may extend any of the first through third example implementations. In the fourth example implementation, at least one pose of the one or more poses provides a profile view of the 3D head model.

A fifth example implementation may extend any of the first through fourth example implementations. In the fifth example implementation, the method further comprises modifying the 3D head model based on data indicating a facial expression.

A sixth example implementation may extend any of the first through fifth example implementations. In the sixth example implementation, the plurality of poses is determined based on input data, the input data comprising data indicating at least one of: a rotation direction of the 3D head model; a rotation speed of the 3D head model; a zoom setting of the 3D head model; or an angle of the 3D head model.

A seventh example implementation may extend any of the first through sixth example implementations. In the seventh example implementation, the input data comprises at least one of: user selection data; or position data indicating a real-time position of the head of the patient.

An eighth example implementation may extend any of the first through seventh example implementations. In the eighth example implementation, the altered dentition of the patient comprises a planned future condition of a dentition of the patient during dental treatment or after completion of dental treatment.

A ninth example implementation may extend any of the first through eighth example implementations. In the ninth example implementation, the altered dentition corresponds to a first stage of a multi-stage orthodontic treatment, the method further comprising: obtaining a third 3D dentition model comprising a depiction of a second altered dentition of the patient that corresponds to a second stage of the multi-stage orthodontic treatment; generating one or more third images of the third 3D dentition model corresponding to at least some of the one or more poses based at least in part on the result of the registering; and generating additional modified versions of the one or more first images by replacing the current dentition of the patient with the second altered dentition of the patient from the one or more third images.

A tenth example implementation may extend any of the first through ninth example implementations. In the tenth example implementation, the method further comprises: generating a video comprising a plurality of video frames that include at least some of the modified versions of the one or more first images and at least some of the additional modified versions of the one or more first images, wherein: a first video frame of the plurality of video frames depicts the altered dentition, and a second video frame of the plurality of video frames depicts the second altered dentition.

An eleventh example implementation may extend any of the first through tenth example implementations. In the eleventh example implementation, generating the modified versions of the one or more first images comprises: inputting the one or more first images into a trained machine learning model to obtain a position of the current dentition in the one or more first images; and disposing a depiction of the second 3D dentition model from the one or more second images at the position of the current dentition.

A twelfth example implementation may extend any of the first through eleventh example implementations. In the twelfth example implementation, the method further comprises modifying a color of the second 3D dentition model based on user input.

A thirteenth example implementation may extend any of the first through twelfth example implementations. In the thirteenth example implementation, the first 3D dentition model was generated from a plurality of intraoral scans captured by an intraoral scanner.

A fourteenth example implementation may extend any of the first through thirteenth example implementations. In the fourteenth example implementation, the method further comprises storing the modified versions of the one or more first images in a datastore.

A fifteenth example implementation may extend any of the first through fourteenth example implementations. In the fifteenth example implementation, the method further comprises sending the modified versions of the one or more first images to a remote computing device.

An additional implementation may extend any of the first through fifteenth implementations. In the additional implementation, a system comprises one or more processors and a memory coupled to the one or more processors, the memory storing computer program instructions that, when executed by the one or more processors, cause the one or more processors to perform the method of the first through fifteenth implementations.

A further implementation may extend any of the first through fifteenth implementations. In the further implementation, a computer readable medium comprises instructions that, when executed by one or more processors, cause the one or more processors to perform the method of any of the first through fifteenth implementations.

A sixteenth example implementation includes a system comprising: one or more processors; and a memory coupled to the one or more processors, the memory storing computer program instructions that, when executed by the one or more processors, perform a computer-implemented method comprising: obtaining a three-dimensional (3D) head model comprising a depiction of a current head of a patient, wherein the 3D head model comprises a representation of at least a portion of a current dentition of the patient, obtaining a first 3D dentition model comprising a depiction of the current dentition of the patient and a second 3D dentition model comprising a depiction of an altered dentition of the patient, registering the first 3D dentition model to the 3D head model, generating one or more first images of the 3D head model in one or more poses, generating one or more second images of the second 3D dentition model corresponding to the one or more poses based at least in part on a result of the registering, and generating modified versions of the one or more first images by replacing the current dentition of the patient with the altered dentition of the patient from the one or more second images.

A seventeenth example implementation may extend the sixteenth example implementation. In the seventeenth example implementation, one or more transformation matrices are generated based on the registering of the first 3D dentition model to the 3D head model, and wherein the one or more transformation matrices and the one or more poses are used to generate the one or more second images.

An eighteenth example implementation may extend any of the sixteenth through seventeenth example implementations. In the eighteenth example implementation, the computer-implemented method further comprises generating a video comprising a plurality of video frames, wherein each video frame of the plurality of video frames comprises at least one of the modified versions of the one or more first images.

A nineteenth example implementation may extend any of the sixteenth through eighteenth example implementations. In the nineteenth example implementation, at least one pose of the one or more poses provides a profile view of the 3D head model.

A twentieth example implementation may extend any of the sixteenth through nineteenth example implementations. In the twentieth example implementation, the computer-implemented method further comprises modifying the 3D head model based on data indicating a facial expression.

A twenty-first example implementation may extend any of the sixteenth through twentieth example implementations. In the twenty-first example implementation, the plurality of poses is determined based on input data, the input data comprising data indicating at least one of: a rotation direction of the 3D head model; a rotation speed of the 3D head model; a zoom setting of the 3D head model; or an angle of the 3D head model.

A twenty-second example implementation may extend any of the sixteenth through twenty-first example implementations. In the twenty-second example implementation, the input data comprises at least one of: user selection data; or position data indicating a real-time position of the current head of the patient.

A twenty-third example implementation may extend any of the sixteenth through twenty-second example implementations. In the twenty-third example implementation, the altered dentition of the patient comprises a planned future condition of a dentition of the patient during dental treatment or after completion of dental treatment.

A twenty-fourth example implementation may extend any of the sixteenth through twenty-third example implementations. In the twenty-fourth example implementation, the altered dentition corresponds to a first stage of a multi-stage orthodontic treatment, the method further comprising: obtaining a third 3D dentition model comprising a depiction of a second altered dentition of the patient that corresponds to a second stage of the multi-stage orthodontic treatment; generating one or more third images of the third 3D dentition model corresponding to at least some of the one or more poses based at least in part on the result of the registering; and generating additional modified versions of the one or more first images by replacing the current dentition of the patient with the second altered dentition of the patient from the one or more third images.

A twenty-fifth example implementation may extend any of the sixteenth through twenty-fourth example implementations. In the twenty-fifth example implementation, the computer-implemented method further comprises: generating a video comprising a plurality of video frames that include at least some of the modified versions of the one or more first images and at least some of the additional modified versions of the one or more first images, wherein: a first video frame of the plurality of video frames depicts the altered dentition, and a second video frame of the plurality of video frames depicts the second altered dentition.

A twenty-sixth example implementation may extend any of the sixteenth through twenty-fifth example implementations. In the twenty-sixth example implementation, generating the modified versions of the one or more first images comprises: inputting the one or more first images into a trained machine learning model to obtain a position of the current dentition in the one or more first images; and disposing a depiction of the second 3D dentition model from the one or more second images at the position of the current dentition.

A twenty-seventh example implementation may extend any of the sixteenth through twenty-sixth example implementations. In the twenty-seventh example implementation, the computer-implemented method further comprises modifying a color of the second 3D dentition model based on user input.

A twenty-eighth example implementation may extend any of the sixteenth through twenty-seventh example implementations. In the twenty-eighth example implementation, the first 3D dentition model was generated from a plurality of intraoral scans captured by an intraoral scanner.

A twenty-ninth example implementation may extend any of the sixteenth through twenty-eighth example implementations. In the twenty-ninth example implementation, the computer-implemented method further comprises storing the modified versions of the one or more first images in a datastore.

A thirtieth example implementation may extend any of the sixteenth through twenty-ninth example implementations. In the thirtieth example implementation, the computer-implemented method further comprises sending the modified versions of the one or more first images to a remote computing device.

A thirty-first example implementation includes a non-transitory computer-readable storage medium with instructions stored thereon, wherein the instructions, when executed by one or more processors, perform a computer-implemented method comprising: obtaining a three-dimensional (3D) head model comprising a depiction of a current head of a patient, wherein the 3D head model comprises a representation of at least a portion of a current dentition of the patient; obtaining a first 3D dentition model comprising a depiction of the current dentition of the patient and a second 3D dentition model comprising a depiction of an altered dentition of the patient; registering the first 3D dentition model to the 3D head model; generating one or more first images of the 3D head model in one or more poses; generating one or more second images of the second 3D dentition model corresponding to the one or more poses based at least in part on a result of the registering; and generating modified versions of the one or more first images by replacing the current dentition of the patient with the altered dentition of the patient from the one or more second images.

A thirty-second example implementation may extend the thirty-first example implementation. In the thirty-second example implementation, one or more transformation matrices are generated based on the registering of the first 3D dentition model to the 3D head model, and wherein the one or more transformation matrices and the one or more poses are used to generate the one or more second images.

A thirty-third example implementation may extend any of the thirty-first through thirty-second example implementations. In the thirty-third example implementation, the computer-implemented method further comprises generating a video comprising a plurality of video frames, wherein each video frame of the plurality of video frames comprises at least one of the modified versions of the one or more first images.

A thirty-fourth example implementation may extend any of the thirty-first through thirty-third example implementations. In the thirty-fourth example implementation, at least one pose of the one or more poses provides a profile view of the 3D head model.

A thirty-fifth example implementation may extend any of the thirty-first through thirty-fourth example implementations. In the thirty-fifth example implementation, the computer-implemented method further comprises modifying the 3D head model based on data indicating a facial expression.

A thirty-sixth example implementation may extend any of the thirty-first through thirty-fifth example implementations. In the thirty-sixth example implementation, the plurality of poses is determined based on input data, the input data comprising data indicating at least one of: a rotation direction of the 3D head model; a rotation speed of the 3D head model; a zoom setting of the 3D head model; or an angle of the 3D head model.

A thirty-seventh example implementation may extend any of the thirty-first through thirty-sixth example implementations. In the thirty-seventh example implementation, the input data comprises at least one of: user selection data; or position data indicating a real-time position of the current head of the patient.

A thirty-eighth example implementation may extend any of the thirty-first through thirty-seventh example implementations. In the thirty-eighth example implementation, the altered dentition of the patient comprises a planned future condition of a dentition of the patient during dental treatment or after completion of dental treatment.

A thirty-ninth example implementation may extend any of the thirty-first through thirty-eighth example implementations. In the thirty-ninth example implementation, the altered dentition corresponds to a first stage of a multi-stage orthodontic treatment, the method further comprising: obtaining a third 3D dentition model comprising a depiction of a second altered dentition of the patient that corresponds to a second stage of the multi-stage orthodontic treatment; generating one or more third images of the third 3D dentition model corresponding to at least some of the one or more poses based at least in part on the result of the registering; and generating additional modified versions of the one or more first images by replacing the current dentition of the patient with the second altered dentition of the patient from the one or more third images.

A fortieth example implementation may extend any of the thirty-first through thirty-ninth example implementations. In the fortieth example implementation, the computer-implemented method further comprises: generating a video comprising a plurality of video frames that include at least some of the modified versions of the one or more first images and at least some of the additional modified versions of the one or more first images, wherein: a first video frame of the plurality of video frames depicts the altered dentition, and a second video frame of the plurality of video frames depicts the second altered dentition.

A forty-first example implementation may extend any of the thirty-first through fortieth example implementations. In the forty-first example implementation, generating the modified versions of the one or more first images comprises: inputting the one or more first images into a trained machine learning model to obtain a position of the current dentition in the one or more first images; and disposing a depiction of the second 3D dentition model from the one or more second images at the position of the current dentition.

A forty-second example implementation may extend any of the thirty-first through forty-first example implementations. In the forty-second example implementation, the computer-implemented method further comprises modifying a color of the second 3D dentition model based on user input.

A forty-third example implementation may extend any of the thirty-first through forty-second example implementations. In the forty-third example implementation, the first 3D dentition model was generated from a plurality of intraoral scans captured by an intraoral scanner.

A forty-fourth example implementation may extend any of the thirty-first through forty-third example implementations. In the forty-fourth example implementation, the computer-implemented method further comprises storing the modified versions of the one or more first images in a datastore.

A forty-fifth example implementation may extend any of the thirty-first through forty-fourth example implementations. In the forty-fifth example implementation, the computer-implemented method further comprises sending the modified versions of the one or more first images to a remote computing device.

A forty-sixth example implementation includes a system comprising: a first computing device configured to: obtain a three-dimensional (3D) head model comprising a depiction of a current head of a patient, wherein the 3D head model comprises a representation of at least a portion of a current dentition of the patient, obtain a first 3D dentition model comprising a depiction of the current dentition of the patient and a second 3D dentition model comprising a depiction of an altered dentition of the patient, register the first 3D dentition model to the 3D head model, generate one or more first images of the 3D head model in one or more poses, and generate one or more second images of the second 3D dentition model corresponding to the one or more poses based at least in part on a result of the registering.

A forty-seventh example implementation may extend the forty-sixth example implementation. In the forty-seventh example implementation, the first computing device is further configured to transmit the one or more first images and the one or more second images to a second computing device, the system further comprising: the second computing device, configured to generate modified versions of the one or more first images by replacing the current dentition of the patient with the altered dentition of the patient from the one or more second images.

A forty-eighth example implementation may extend any of the forty-sixth through forty-seventh example implementations. In the forty-eighth example implementation, the second computing device is further configured to generate a video comprising a plurality of video frames, wherein each video frame of the plurality of video frames comprises at least one of the modified versions of the one or more first images.

A forty-ninth example implementation may extend any of the forty-sixth through forty-eighth example implementations. In the forty-ninth example implementation, one or more transformation matrices are generated based on the registering of the first 3D dentition model to the 3D head model, and wherein the one or more transformation matrices and the one or more poses are used to generate the one or more second images.

A fiftieth example implementation may extend any of the forty-sixth through forty-ninth example implementations. In the fiftieth example implementation, at least one pose of the one or more poses provides a profile view of the 3D head model.

A fifty-first example implementation may extend any of the forty-sixth through fiftieth example implementations. In the fifty-first example implementation, the computer-implemented method further comprises modifying the 3D head model based on data indicating a facial expression.

A fifty-second example implementation may extend any of the forty-sixth through fifty-first example implementations. In the fifty-second example implementation, the plurality of poses is determined based on input data, the input data comprising data indicating at least one of: a rotation direction of the 3D head model; a rotation speed of the 3D head model; a zoom setting of the 3D head model; or an angle of the 3D head model.

A fifty-third example implementation may extend any of the forty-sixth through fifty-second example implementations. In the fifty-third example implementation, the input data comprises at least one of: user selection data; or position data indicating a real-time position of the current head of the patient.

A fifty-fourth example implementation may extend any of the forty-sixth through fifty-third example implementations. In the fifty-fourth example implementation, the altered dentition of the patient comprises a planned future condition of a dentition of the patient during dental treatment or after completion of dental treatment.

A fifty-fifth example implementation may extend any of the forty-sixth through fifty-fourth example implementations. In the fifty-fifth example implementation, the first computing device is further configured to: generate modified versions of the one or more first images by replacing the current dentition of the patient with the altered dentition of the patient from the one or more second images; and transmit the modified versions of the one or more first images to a remote computing device.

A fifty-sixth example implementation may extend any of the forty-sixth through fifty-fifth example implementations. In the fifty-sixth example implementation, the altered dentition corresponds to a first stage of a multi-stage orthodontic treatment, wherein the first computing device is further configured to: obtain a third 3D dentition model comprising a depiction of a second altered dentition of the patient that corresponds to a second stage of the multi-stage orthodontic treatment; generate one or more third images of the third 3D dentition model corresponding to at least some of the one or more poses based at least in part on the result of the registering; and generate one or more additional modified versions of the one or more first images by replacing the current dentition of the patient with the second altered dentition of the patient from the one or more third images.

A fifty-seventh example implementation may extend any of the forty-sixth through fifty-sixth example implementations. In the fifty-seventh example implementation, the first computing device is further configured to: generate a video comprising a plurality of video frames that include at least some of the modified versions of the one or more first images and at least some of the additional modified versions of the one or more first images, wherein: a first video frame of the plurality of video frames depicts the altered dentition, and a second video frame of the plurality of video frames depicts the second altered dentition.

A fifty-eighth example implementation may extend any of the forty-sixth through fifty-seventh example implementations. In the fifty-eighth example implementation, generating the modified versions of the one or more first images comprises: inputting the one or more first images into a trained machine learning model to obtain a position of the current dentition in the one or more first images; and disposing a depiction of the second 3D dentition model from the one or more second images at the position of the current dentition.

A fifty-ninth example implementation may extend any of the forty-sixth through fifty-eighth example implementations. In the fifty-ninth example implementation, the first computing device is further configured to store the modified versions of the one or more first images in a datastore.

A sixtieth example implementation may extend any of the forty-sixth through fifty-ninth example implementations. In the sixtieth example implementation, the first computing device is further configured to send the modified versions of the one or more first images to a second computing device.

A sixty-first example implementation may extend any of the forty-sixth through sixtieth example implementations. In the sixty-first example implementation, the first computing device is further configured to modify a color of the second 3D dentition model based on user input.

A sixty-second example implementation may extend any of the forty-sixth through sixty-first example implementations. In the sixty-second example implementation, the first 3D dentition model was generated from a plurality of intraoral scans captured by an intraoral scanner.

A sixty-third example implementation includes a system comprising: a first computing device configured to: obtain a three-dimensional (3D) head model comprising a depiction of a current head of a patient, wherein the 3D head model comprises a representation of at least a portion of a current dentition of the patient, obtain a first 3D dentition model comprising a depiction of the current dentition of the patient and a second 3D dentition model comprising a depiction of an altered dentition of the patient, and generate a video of a post-treatment head of the patient that includes the altered dentition of the patient based on the first dentition model, the second dentition model, and the head model.

A sixty-fourth example implementation may extend the sixty-third example implementation. In the sixty-fourth example implementation, the first computing device is further configured to: transmit the video to a remote computing device for storage and/or display t

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing can be advantageous.

What is claimed is:

1. A system, comprising:
a first computing device configured to:
obtain a three-dimensional (3D) head model comprising a depiction of a current head of a patient, wherein the 3D head model comprises a representation of at least a portion of a current dentition of the patient,
obtain a first 3D dentition model comprising a depiction of the current dentition of the patient and a second 3D dentition model comprising a depiction of an altered dentition of the patient,
register the first 3D dentition model to the 3D head model,
generate one or more first images of the 3D head model in one or more poses, and
generate one or more second images of the second 3D dentition model corresponding to the one or more poses based at least in part on a result of the registering.

2. The system of claim 1, wherein the first computing device is further configured to transmit the one or more first images and the one or more second images to a second computing device, the system further comprising:
the second computing device, configured to generate modified versions of the one or more first images by replacing the current dentition of the patient with the altered dentition of the patient from the one or more second images.

3. The system of claim 2, wherein the second computing device is further configured to generate a video comprising a plurality of video frames, wherein each video frame of the plurality of video frames comprises at least one of the modified versions of the one or more first images.

4. The system of claim 1, wherein one or more transformation matrices are generated based on the registering of the first 3D dentition model to the 3D head model, and wherein the one or more transformation matrices and the one or more poses are used to generate the one or more second images.

5. The system of claim 1, wherein at least one pose of the one or more poses provides a profile view of the 3D head model.

6. The system of claim 1, wherein the first computing device is further configured to modify the 3D head model based on data indicating a facial expression.

7. The system of claim 1, wherein the one or more poses are determined based on input data, the input data comprising data indicating at least one of:
a rotation direction of the 3D head model;
a rotation speed of the 3D head model;
a zoom setting of the 3D head model; or
an angle of the 3D head model.

8. The system of claim 7, wherein the input data comprises at least one of:
user selection data; or
position data indicating a real-time position of the current head of the patient.

9. The system of claim 1, wherein the altered dentition of the patient comprises a planned future condition of a dentition of the patient during dental treatment or after completion of dental treatment.

10. The system of claim 1, wherein the first computing device is further configured to:
generate modified versions of the one or more first images by replacing the current dentition of the patient with the altered dentition of the patient from the one or more second images; and
transmit the modified versions of the one or more first images to a remote computing device.

11. The system of claim 10, wherein the altered dentition corresponds to a first stage of a multi-stage orthodontic treatment, wherein the first computing device is further configured to:
obtain a third 3D dentition model comprising a depiction of a second altered dentition of the patient that corresponds to a second stage of the multi-stage orthodontic treatment;
generate one or more third images of the third 3D dentition model corresponding to at least some of the one or more poses based at least in part on the result of the registering; and
generate one or more additional modified versions of the one or more first images by replacing the current dentition of the patient with the second altered dentition of the patient from the one or more third images.

12. The system of claim 11, wherein the first computing device is further configured to:
generate a video comprising a plurality of video frames that include at least some of the modified versions of the one or more first images and at least some of the additional modified versions of the one or more first images, wherein:
a first video frame of the plurality of video frames depicts the altered dentition, and
a second video frame of the plurality of video frames depicts the second altered dentition.

13. The system of claim 10, wherein generating the modified versions of the one or more first images comprises:
inputting the one or more first images into a trained machine learning model to obtain a position of the current dentition in the one or more first images; and
disposing a depiction of the second 3D dentition model from the one or more second images at the position of the current dentition.

14. The system of claim 10, wherein the first computing device is further configured to at least one of store the modified versions of the one or more first images in a datastore or send the modified versions of the one or more first images to a second computing device.

15. The system of claim 1, wherein the first computing device is further configured to modify a color of the second 3D dentition model based on user input.

16. A system, comprising:
a first computing device configured to:
obtain a three-dimensional (3D) head model comprising a depiction of a current head of a patient, wherein the 3D head model comprises a representation of at least a portion of a current dentition of the patient,
obtain a first 3D dentition model comprising a depiction of the current dentition of the patient and a second 3D dentition model comprising a depiction of an altered dentition of the patient, and
generate a video of a post-treatment head of the patient that includes the altered dentition of the patient based on the first 3D dentition model, the second 3D dentition model, and the 3D head model.

17. The system of claim 16, wherein the first computing device is further configured to:
transmit the video to a remote computing device for storage and/or display thereon.

18. A method, comprising:
obtaining a three-dimensional (3D) head model comprising a depiction of a current head of a patient, wherein the 3D head model comprises a representation of at least a portion of a current dentition of the patient;
obtaining a first 3D dentition model comprising a depiction of the current dentition of the patient and a second 3D dentition model comprising a depiction of an altered dentition of the patient;
registering the first 3D dentition model to the 3D head model;
generating one or more first images of the 3D head model in one or more poses;
generating one or more second images of the second 3D dentition model corresponding to the one or more poses based at least in part on a result of the registering; and
generating modified versions of the one or more first images by replacing the current dentition of the patient with the altered dentition of the patient from the one or more second images, wherein the modified versions of the one or more first images are photorealistic.

19. The method of claim 18, wherein one or more transformation matrices are generated based on the registering of the first 3D dentition model to the 3D head model, and wherein the one or more transformation matrices and the one or more poses are used to generate the one or more second images.

20. The method of claim 18, further comprising generating a video comprising a plurality of video frames, wherein each video frame of the plurality of video frames comprises at least one of the modified versions of the one or more first images.
